(19) United States
(12) Patent Application Publication
(10) Pub. No.: US 2005/0096973 A1
(43) Pub. Date: May 5, 2005

(54) Automated life and career management services

(76) Inventors: Neil W. Heyse, Bryn Mawr, PA (US); Kristy A. Heyse, Wayne, PA (US)

Correspondence Address: WERNER & AXENFELD, LLP, P. O. BOX 1629, WEST CHESTER, PA, 19380, US

(21) Appl. No.: 10/980,688

(22) Filed: Nov. 3, 2004

Related U.S. Application Data
(60) Provisional application No. 60/517,141, filed on Nov. 4, 2003.

(51) Int. Cl. G06F 17/60

(52) U.S. Cl. 705/11; 705/1

(57) ABSTRACT

Integrated life and career management systems and methods for providing comprehensive life and career management services to individuals over a network, such as the Internet are described. The integrated life and career management systems and methods allow individuals to dynamically and continuously record, witness, monitor, and manage their life and career development. Professional advisors may access and reference information about individuals to render assistance to the individual. In one implementation, a dynamic personal growth and development profile is automatically constructed and recorded based on tests, instruments, and exercises taken by the individual. The profile provides a psychometric self-portrait of the individual among other information. A comprehensive and flexible life and career plan corresponding to the profile is generated, so as to provide guidance to the individual when life and career decisions are made.

### CROSS-REFERENCE TO RELATED APPLICATIONS

The present patent application claims benefit of U.S. Provisional Application Ser. No. 60/517,141 filed on Nov. 4, 2003. The content of the aforementioned application is fully incorporated by reference herein.

### TECHNICAL FIELD

The present invention relates to using automated computer systems and methodologies to deliver life and career management support services to individuals to enable them to manage their life and careers more successfully.

### BACKGROUND

While America's colleges and universities continually attract brighter and better-educated young men and women, fewer and fewer students feel adequately prepared or sufficiently informed to confidently make major personal life and career decisions, including education-related decisions that shape the direction of post-graduation career options. At the same time, people in their twenties are recognizing that the early choices they make following their formal education will have a profound impact on their future life and career. In part this dilemma is the result of societal and economic changes happening at the speed of light, an ever-increasing expansion of global opportunities, the rapid advancement of technology, and the overall complexity associated with day-to-day living in a modern world.

The net effect is that it is becoming more and more difficult, if not impossible, for an individual to make the best educated choices regarding career and life decisions. By the time students complete sixteen years of formal education, they have been exposed to more than 14,000 hours of classroom instruction that is principally concentrated on external world subject matter, with little, if any, structured time devoted to discovering their fundamentally important internal world.

Compounding the effects of this limited focus is the infinite number of career path options and lifestyle alternatives available to young people, which causes them to wonder how to identify all of the options available and how to choose the most appropriate option.

In a simpler age, an individual could get along leisurely managing his life and career on the basis of his own wits and the advice of a few friends or family members. In a complex, informational age, an individual needs assistance simply to survive . . . and considerably more to succeed.

A high percentage of college students and young working adults commonly experience what is termed a “Career Confusion Syndrome,” which is a condition characterized by anxiety and frustration associated with an individual's inability to logically and confidently select the career path that is most compatible with their personality, interests, values, tenants, competencies, etc. Additionally, many people from all age groups lack a clear, conscious personal identity or self-concept.

The combination of the foregoing conditions leaves individuals with no choice other than to experiment, sometimes haphazardly, with different educational and occupational experiences in order to identify the appropriate choice. This experimental discovery process commonly results in: a series of false starts; dead ends; waste of a high percentage of what otherwise would be more productive and rewarding working years; a high risk that the best career alternative may never be discovered; an under-utilization of human resource talent; and the preclusion of an opportunity to constructively develop an integrated, satisfying life and career.

Currently, individuals may seek employment and career counseling through some type of career planning software. Such tools are usually limited to a single purpose, such as drafting resumes, networking techniques, letter writing and interviewing, finding and securing a job, compensation associated with a profession, etc. Accordingly, most career planning software tools are separate, narrowly focused, near-term purpose event-oriented tools that tend to offer static solutions for the individual. Any career counseling and guidance associated with such career planning tools is thus typically limited to single encounters at the time the individual requires that specific service.

Individuals may also seek to better manage and improve the quality of their lives. Yet, few, if any, individuals have access to methodologies, techniques or supportive assistance necessary to enable them to manage their life intelligently. Our culture tends to leave people on their own when devising a life strategy, which typically occurs on a random or chance basis as time progresses. Where advisory or other type of assistance is involved, it is often experienced on a short encounter, interventional, fragmented basis and typically applied on only the most perfunctory level.

In the absence of better alternatives, individuals often rely on their instincts, friends, family, and apparent opportunities to guide their life course. Frequently, reliance on a subconscious type of internal guidance system results in inappropriate choices, resulting in less than desirable and sometimes-irreversible life circumstances. It is not uncommon for individuals to make important life decisions in response to near term pressures, as opposed to making these important decisions on a strategic, proactive basis in pursuit of logically developed, long range goals consistent with their true inner needs, desires and capabilities. It is commonly recognized that in a lifetime, many individuals realize only a small fraction of their true human potential.

To the extent that individuals may seek help with improving their lives through current life improvement tools, they are generally limited to choosing from self-help books, self-help tapes, or software tools modeled after the self-help books/tapes. Each of these improvement tools tends to fail the individual, because most individuals lack the self-discipline, expertise, and/or know-how to effectively apply the knowledge contained in these life improvement tools on their own and on a consistent and continuing basis. Additionally, most of these life improvement tools only reach a small fraction of the population and most lack consistency of interpretation. Many individuals typically use the knowledge of these improvement tools for a specific and near-term purpose. They often discard their findings and fail to connect their importance in meeting future life-career management needs.

Accordingly, most individuals are unable to use traditional life improvement tools to effectuate positive improvement in their lives and careers over extended periods of time.

### SUMMARY

An automated life and career management system for providing comprehensive life and career management services to an individual over a network, such as the Internet, is described. The life and career management system permits an individual to create, modify, update and actively reference information pertaining to the establishment and improvement of their career while simultaneously managing their life more effectively. An individual using the system may complete successive personal discovery and life/career planning segments online and receive feedback regarding their progress including suggested steps the individual might consider taking to achieve their important life and career goals. Over time the system constructs a dynamic personal development profile for the individual that provides a clear, psychometric self-portrait together with a compressive yet flexible, life-career plan to support intelligent life/career decision-making.

The individual may also receive periodic recommendations and summary overviews of life and career management ideas and techniques, which are targeted to their specific needs and may include occupational opportunities corresponding to their current profile and possible life and career goals developed through the use of the system. Professional advisors may also access and reference information about the individual, such as the personal development profile, to render guidance to the individuals upon request when the individual is confronted with a life, a career, or a financial issue.

In one exemplary implementation, the system includes life and career management modules and a user interface for interacting with the life and career management modules. The program modules may include a number of program and/or logic components configured to perform a variety of different functions associated with providing integrated life and career management services to individuals.

Such services may include: developing a personal psychological profile of an individual; providing career exploration and guidance to an individual; providing interactive personal planning and goal setting in separate but interrelated life arenas, such as personal, occupational, financial, social, educational, leisure and/or spiritual arenas; enabling monitoring of achievements and performance of life and career plans formulated by the individual including managing and developing specific integrated life and career objectives for an individual; offering instructional life and career management training skills to an individual; and providing online life advisory guidance to an individual, such as through an advisor that has access to information compiled and recorded about an individual, and various other life and career management services.

In one exemplary implementation, the life and control management modules include a personal growth and development facilitator module. This module is configured to allow an individual to take a series of personality tests, psychological assessment instruments and introspective exercises that identify interrelationships, patterns, consistencies and inconsistencies among various distinguishing thought—feeling and behavioral characteristics including: extroversion, agreeableness, conscientiousness, openness, coping and well-being, values, interests, motivations, talents, abilities and learned skills. The individual can take the introspectively stimulating series of psychological assessment personality tests and introspective exercises in response to prompts. Over time, the life and control management module can conveniently construct, and record, a dynamic personal growth and development profile about an individual that provides a clear, psychometric self-portrait together with a comprehensive yet flexible, life-career plan to support intelligent life and career decision-making.

The personal growth and development facilitator module may also present (i.e., display, report, transmit) one or more portions of the personal growth and development profile in three dimensions (i) a current-self, (ii) a perceived-self, and (iii) a desired-self. The “current-self” describes what the individual is at the time of completing or updating the personality tests, psychological assessment instruments and introspective exercises. The “perceived-self” describes how the individual is perceived by others on the same scales used to determine the current-self. The “desired-self” describes a person the individual hopes to become in the future. Through the personal growth and development profile, an individual can consciously and proactively develop distinguishing personality characteristics into strengths that can be referenced and used by the individual throughout the natural process of transitioning through life events.

In one exemplary implementation, the life and control management modules include a career development module. This module is configured to assist the individual in systematically screening, filtering, identifying and evaluating career alternatives for the individual, some of which may be based on information selected from the personal growth and development profile. For example, the career development manager module is configured to select personality traits from the personal growth and development profile, and assist the individual to identify at least one best fit candidate career path, secondary candidate career path, and a tertiary candidate career path that matches the selected personality traits and interests. Additionally, the life and control management modules is configured to automatically project a career path over an entire career span including prospective position titles, period holding each title and estimated incomes for each title. Based on information provided by the individual, the career development module is able to record and present a career development plan for use by the individual.

In one exemplary implementation, the life and control management modules include a planning and goal setting module. This module is configured to allowing an individual to participate in a series of exercises that enable the system to ascertain an individual's goals, automatically rank the goals based on information provided by the individual, and generate a comprehensive and personalized action plan for the individual to follow over time for career and life planning processes. The module may organize the planning processes into life arenas comprising a personal arena, an occupational arena, a financial arena, a social arena, an educational arena, a leisure arena, and a spiritual arena. The module may also display core values about the individual gleaned from the personal growth and development profile for reference when participating in goal setting and planning exercises so that the individual is able to keep in the forefront real-time information to assist in the goal setting and planning processes.

In one exemplary implementation, the life and control management modules include a job procurement assistant module. This module is configured to identify job opportunities from one or more Internet sources or databases that are consistent with a career development plan and/or one or more aspects of the personal growth and development profile developed earlier.

In one exemplary implementation, the life and control management modules include an achievement and performance monitoring module. This module is intended to facilitate management of personal priorities, such as goals and plans established by the planning and goal setting module. For example, the achievement and performance monitoring module is configured to display a control console comprising a display area containing one or more goal charts each classified by a particular type of goal, each goal chart providing an indication of progress to achieving the one or more goals. In certain circumstances, alerts may be issued if a goal is not reached or is below expectations. For example, if an expense exceeds a particular budget level an alert may be generated.

In one exemplary implementation, the life and control management modules include a life skills developer module configured to disseminate educational information associated with improving life skills to an individual. This dissemination of information may include topics related to achieving results, networking for success, personal time management, winning at human relations, business etiquette and professionalism, leadership skills, emotional intelligence, and so forth.

In one exemplary implementation, the life and control management modules include a management support and advisory module, configured to enable an individual to interact with an advisor to provide guidance to the individual when confronted with life and career issues. The advisor is able to access information recorded about the individual recorded by other modules.

Thus, the automated life and career management control system delivers comprehensive, dynamic, and integrated life and career management services to enable an individual to understand himself, empower him to better prepare for or organize his education, adopt a set of clearly defined goals, and attain control of a meaningful direction in life over extended periods of time. The automated life and career management control system described herein is process oriented to manage and develop life and careers in both the short run and long run (vs. event or sporadic interventional approaches), because life and career matters are dynamic rather static. Additionally, the combination of interactive modules and technology with informational supported coaching/counseling/advising is designed to enable an individual to continually use the tools associated with the automated life and career management control system, and update their records and benefit from ongoing, continuous assistance to manage their life and career proactively as certain non-controllable events take place in the outside world.

Related methods of use, system, and interface implementations are described herein.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 shows a network environment in which life and career management services may be rendered.

FIG. 2 is a block diagram showing an example computer within which various functionalities described herein can be fully or partially implemented.

FIG. 3 is a block diagram showing components of an exemplary life-career module.

FIG. 4 illustrates a portion of a user interface control panel rendered in a display region of a display device of a client device by a life-career management system executing computer software instructions (i.e., logic) associated with a life-career module.

FIG. 5 shows an exemplary page of a control panel displayed in a display area of a user interface display device on a client device, which is rendered by the life-career management system when in a mode of operation controlled by a personal growth and development module.

FIG. 6 shows an exemplary format of a personality test displayed on a display device of a client device when the individual selects a communications skills selection item in the control panel.

FIG. 7A shows a portion of a multiple page communications skills summary report presented to an individual, which can be presented in a Web-based online format, electronic message (such as e-mail), and/or as a printed document.

FIG. 7B shows types of assessment reports that are recorded and electronically disseminated to the individual after completion of each personality assessment.

FIG. 8 illustrates one example of the types open-ended questions asked with respect to the introspective exercises presented on a user interface.

FIG. 9A shows a summary report summarizing results from a desired-self questionnaire introspective exercise.

FIG. 9B shows types of assessment reports that are recorded and disseminated to the individual after completion of each introspective exercise.

FIG. 10 shows assorted tools produced by personal growth and development module associated with enabling an individual to gather observations and perceptions from others (third party perceivers) about the particular individual automatically.

FIG. 11 shows a page in a display area of a display device rendered when the individual clicks on a personal mission icon.

FIG. 12 shows a first portion of a Personal Growth and Development Facilitator (PGDF) Report dealing with personality traits displayed in a display region of a graphical user interface.

FIG. 13 shows a display region of a user interface containing a graphical domain summary summarizing one of the personality traits from FIG. 12 in three dimensions.

FIG. 14 shows a section of a personnel profile detailing the most significant personality characteristics of the individual extracted from the PDGF Report.

FIG. 15 illustrates a method to implement functionality associated with the Personal Growth and Development Module.

FIG. 16 shows an exemplary page of a control panel displayed on a user interface of a client device produced by a career development facilitator module.

FIG. 17 shows a sample life role balance evaluator exercise and a portion of Career Foundation Report produced as a result of completing the life role balance evaluator exercise.

FIG. 18 shows other portions of the career foundation report which is associated with other exercises and questionnaires provided by the career development module.

FIG. 19 shows a career channel wizard.

FIG. 20 shows an exemplary career channel progression forecast of a career over a career span.

FIG. 21 illustrates a method to implement functionality associated with the Career Development Module.

FIG. 22 shows an exemplary page of a control panel displayed on a user interface of a client device produced by a planning and goal setting module.

FIG. 23 shows a sample page (e.g. wizard) rendered on a display device for setting a personal life arena goal.

FIG. 24 shows a sample portion of a page read from database by planning and goal setting module and displayed to an individual or advisor.

FIG. 25 illustrates a method to implement functionality associated with a planning and goal setting module.

FIG. 26 shows an exemplary page of a control panel displayed on a user interface of a client device produced by the job procurement assistant module.

FIG. 27 shows an exemplary page of a control panel displayed on a user interface of a client device produced by the achievement and performance monitoring module.

### DETAILED DESCRIPTION

Exemplary Network Environment

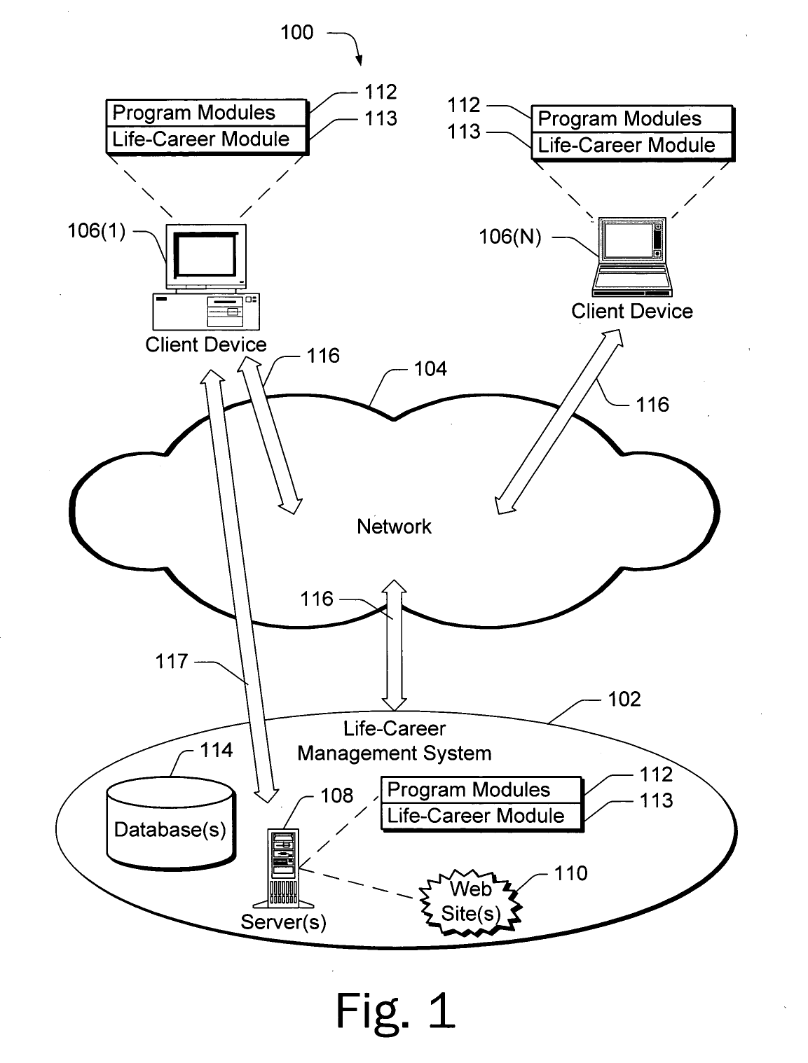

FIG. 1 shows a network environment 100 in which life and career management services may be rendered. Network environment 100 may include a life and career management system (“life-career management system”) 102, a network 104, and one or more client devices 106(1), . . . , 106(N), which are referred to generally as number 106 herein.

Representative life-career management system 102 provides life and career management services to individuals over network 104 (e.g., Internet). Typically a servicing entity, such as a company, an organization, a counseling center, a university, etc., manages life-career management system 102.

Life-career management system 102 is illustrated as including one or more servers 108 that execute software to handle requests from client devices 106 for particular services associated with providing life and career management to individuals. Server 108 may be any type of computing device, such as a server, mainframe computer, enterprise server, workstation, personal computer, or other related devices. Servers 108 may maintain various data associated with servicing individuals in one or more databases 114.

Servers 108 may host one or more Web sites 110 that offer life and career management content to client devices 106 via network 104. The Web content may come in many different forms. One example is a Web page, which is defined as a title, collection of information, pointers or “hyperlinks” to other information, etc. A Web page may be constructed from various types of content including computer data, audio, video, animation, bit maps or other graphics, applications or other executable code, text, hypermedia, or other multimedia types, etc. Another example of Web content is a video or audio recording that can be played at the server and transmitted over network 104 to one or more clients. An individual may use client devices 104 to perform actions while on a page of the Web site by selecting a certain icon, link, etc. to be transferred to a different page, menu, location, etc. or to cause an action to occur. For example, such actions may include selecting on or interacting with a menu, traversing from one page to another, answering questions, entering information, etc.

Servers 108 may also manage a collection of program modules 112, that are reusable and interact programmatically over network 104, typically through industry standard Web protocols, such as Extensible markup language (XML), hypertext transport protocol (HTTP), file transfer protocol (FTP), and simple mail transfer protocol (SMTP). Other means of interacting with the Web services over the network may also be used, such as simple object access protocol (SOAP), remote procedure call (RPC), object broker type technology, etc.

Program modules 112 may be combined with each other, share data, create databases 114, or interact with other applications to build an intelligent interactive experience on client devices 106. As shall be described in further detail, program modules may include a number of program and/or logic components such as a life and career (“life-career”) module 113 that are each configured to perform a variety of different functions associated with providing life and career management services to individuals. Such services may include: developing a personal psychological profile of an individual; providing career exploration and guidance to an individual; providing interactive life-career planning to an individual; managing and developing integrated life and career objectives for an individual; offering instructional life and career management training skills to an individual; and providing online life advisory guidance to an individual.

Note that a portion of program modules 112, including life-career module 113, may reside on one or more of client devices 106. Additionally, program modules 112, including life-career module 113, may coordinate with other software on either the server 108 and/or client devices 106 to accomplish tasks.

Client devices 106 can be implemented in many different ways. Examples of possible implementations include, without limitation, portable computers, stationary computers, tablet PCs, wireless communication devices, personal digital assistants, and other smart devices. Each client device 106 enables an individual to communicate and access information from life-career management system 102 via network 104.

Network 104 may be any type of data communication network using any communication protocol. Network 104 may include one or more sub-networks (not shown) which are interconnected to one another. Although only a few devices are shown coupled to network 104 in this example, a particular network may include any number of devices.

Communication links 116 shown between network 104 and various services/devices represent any type of wired and/or wireless link including, but not limited to, a radio frequency link, microwave link, a public telephone network, (e.g., a public switched telephone network (PSTN)), etc. Additionally, it may also be possible for various devices in network environment 100 to communicate directly with other devices without using network 104 as a communication link. For example, it may be possible for server 108 to communicate directly with a client device 106 via a point-to-point connection 117, bypassing network 104.

Network environment 100 is only one example of a computer system environment and is not intended to suggest any limitation as to the scope of use or functionality of the components therein. Neither should environment 100 be interpreted as having any dependency or requirement relating to any one or more or any combination of components illustrated in the exemplary environment 100 shown in FIG. 1. For example, in certain implementations life-career modules may be implemented as a software package designed to operate locally on a computer device, such as client devices 106, without the need to connect to a server over a network.

Having introduced network environment 100 and its constituent components, it is now possible to describe an exemplary computer platform that may be used to implement life-career management system 102, client device 106, or server 108.

Exemplary Computer

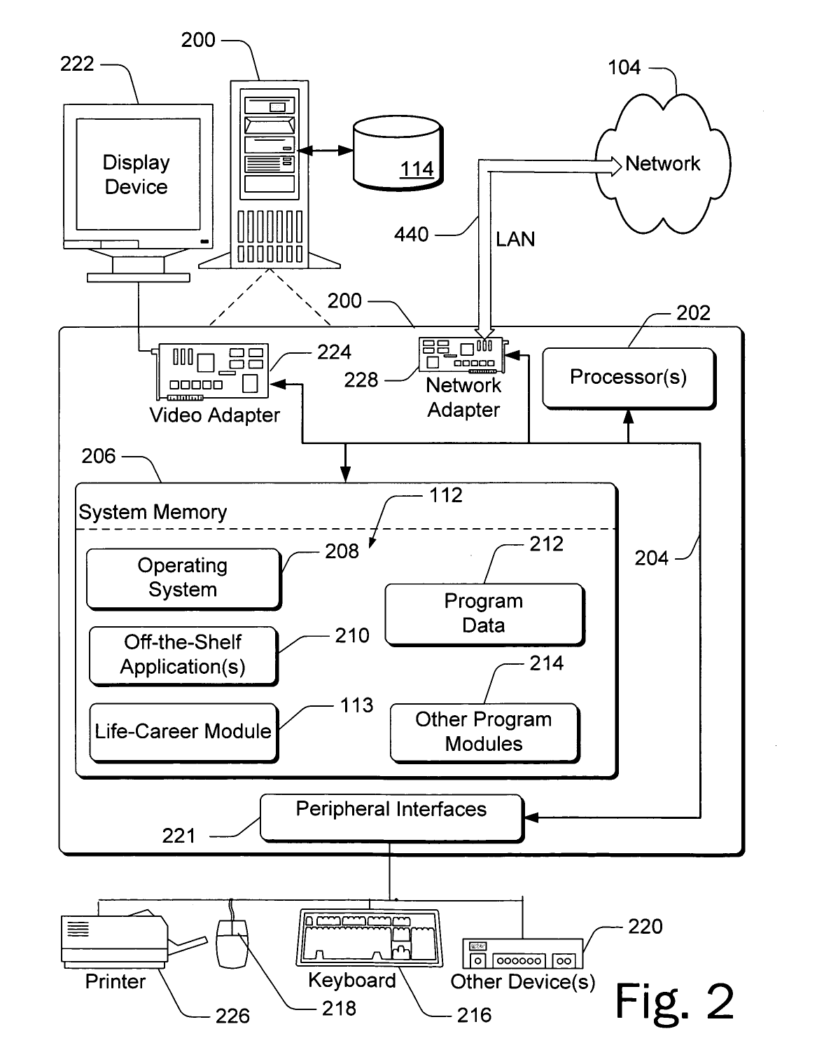

FIG. 2 is a block diagram showing an example computer 200 within which various functionalities described herein can be fully or partially implemented. Computer 200 can function as life-career management system 102 (FIG. 1), server 108 (FIG. 1), client device 106 (FIG. 1), or other type of system.

Computer 200 may include one or more processors 202 coupled to a bus 204. Bus 204 represents one or more of any variety of bus structures and architectures and may also include one or more point-to-point connections.

Computer 200 may also include or have access to memory 206, which represents a variety of computer readable media. Such media can be any available media that is accessible by processor(s) 202 and includes both volatile and non-volatile media, removable and non-removable media. For instance, memory 206 may include computer readable media in the form of volatile memory, such as random access memory (RAM) and/or non-volatile memory in the form of read only memory (ROM). In terms of removable/non-removable storage media or memory media, memory 206 may include a hard disk, a magnetic disk, a floppy disk, an optical disk drive, CD-ROM, flash memory, etc.

Any number of program modules 112 can be stored in memory 206, including by way of example, an operating system 208, off-the-shelf applications 210 (such as e-mail programs, browsers, etc.), program data 212, life-career module 113, and other modules 214. Memory 206 may also include one or more databases 114 (FIG. 1) containing data and information enabling functionality associated with program modules 112.

A user can enter commands and information into computer 200 via input devices such as a keyboard 216 and a pointing device 218 (e.g., a “mouse”). Other device(s) 220 (not shown specifically) may include a microphone, joystick, game pad, serial port, etc. These and other input devices are connected to bus 204 via peripheral interfaces 221, such as a parallel port, game port, universal serial bus (USB), etc.

A display device 222 can also be connected to computer 200 via an interface, such as video adapter 224. In addition to display device 222, other output peripheral devices can include components such as speakers (not shown), or a printer 226.

Computer 200 can operate in a networked environment (see FIG. 1), or a point-to-point environment, (see FIG. 1) using logical connections to one or more remote computers. The remote computers may be personal computers, servers, routers, or peer devices. A network interface adapter 228 may provide access to network 104, such as when network is implemented as a local area network (LAN), or wide area network (WAN), etc.

In a network environment (such as the one depicted in FIG. 1), some or all of the program modules 112 executed by computer 200 may be retrieved from another computing device coupled to the network. For purposes of illustration, life-career module 113 and other executable program components, such as the operating system, are illustrated herein as discrete blocks, although it is recognized that such programs and components reside at various times in different storage components which may be remote or local, and are executed by processor(s) 202 of computer 200 or remote computers.

Having introduced network environment 100, its constituent components, and an exemplary computer platform 200, it is now possible to describe the functionality provided by life-career module 113 in more detail.

Exemplary Life-Career Module

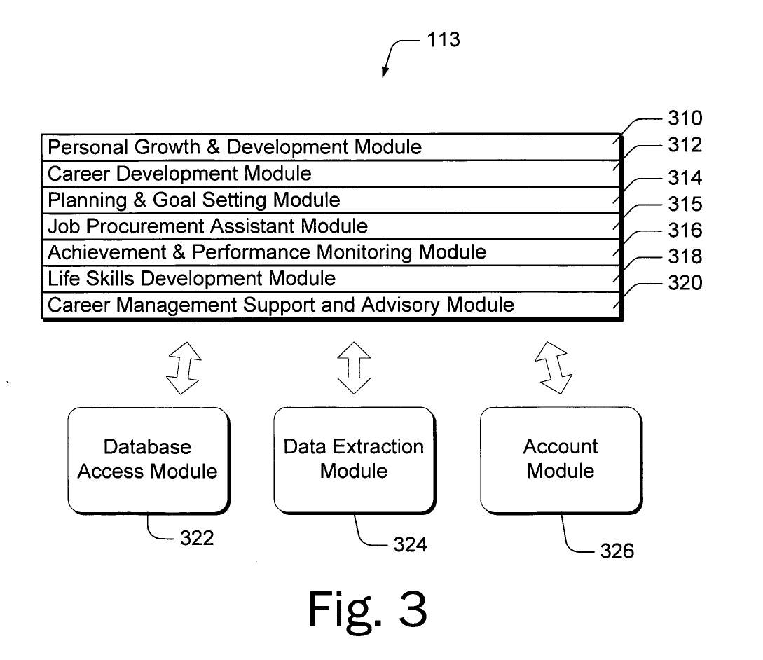

FIG. 3 is a block diagram showing components of an exemplary life-career module 113. In one implementation, life-career module 113 may include: a personal growth and development module 310; a career development module 312; a planning and goal setting module 314; a job procurement assistant module 315, an achievement and performance monitoring module 316; a life skills development module 318; and a career management and support advisory module 320. Collectively, each of these modules (310, 312, 314, 315, 316, 318, 320) provide a runtime environment on client devices 106 that enables individuals to access various services offered by life-career management system 102.

Also, each of these modules (310, 312, 314, 315, 316, 318, and 320) collectively include application logic (e.g., program instructions and program modules) that generates a user interface on a display device 222 (FIG. 2), enabling an individual to: take psychological assessment tests, receive career guidance; receive interactive life-career planning guidance, participate in instructional life and career management training skills, perform various other tasks, and receive other related career and life management information.

Collectively, each of these modules (310, 312, 314, 315, 316, 318, and 320) also record and maintain data in one or more databases 114 in conjunction with database access module 322 (to be described) and data extraction module 324 (to be described). Accordingly, life-career module 113 enables life-career management system 102 to process information and generates reports that may be sent to the individual or to professional coaches, counselors, or advisors so as to render informed life and career guidance to individuals.

For example, personal growth and development module 310 facilitates a mode of operation associated with creating, maintaining, and expanding a dynamic and scalable psychological assessment of an individual.

Career development module 312 facilitates a mode of operation associated with exploring occupational options, developing a dynamic occupational profile of an individual, and channeling career selection in relation to an individual's personality characteristics, worker traits and occupational profile.

Planning and goal setting module 314 facilitates a mode of operation associated with personal planning and goal setting for an individual, which may include an updateable and modifiable comprehensive life and career plan for an individual.

Job procurement assistant module 315 facilitates a mode of operation associated with screening and identifying job opportunities consistent with the career plan and select personality characteristics.

Achievement and performance monitoring module 316 facilitates a mode of operation associated with organizing, assisting, informing and guiding an individual through the dynamic process of implementing, tracking, updating and managing the implementation of life and career plans formulated by career development module 312 and planning and goal setting module 314.

Life skills development module 318 facilitates a mode of operation associated with enabling individuals to learn and develop selected life skills through informative development tutorial information.

Career management support and advisory module 320 facilitates a mode of operation associated with enabling life-career management system 102 to access information recorded and maintained by life-career module 113 in one or more databases 114, and to render informed life and career guidance to individuals through various communication media, such as the Internet, e-mail communications, telephonic communications, voice over Internet protocol (VOIP), video conferencing, and other teleconferencing techniques.

Although each of the modules 310, 312, 314, 315, 316, 318, and 320 are shown as separate components of life-career module 113, it is appreciated that functionality enabled by each of the modules may be segmented, combined with other modules and/or integrated in a different manner. Additional modules may be included in life-career module 113 and some modules as illustrated in life-career module 113 need not be included. For example, a health component module (not shown) dealing with nutrition and health issues of an individual could be added to life-career module 113, and life skills development module 318 may not be included.

It is also noted that each of the aforementioned modules (310, 312, 314, 315, 316, 318, and 320) have access to background logic, such as a database access module 322, a data extraction module 324, and an account module 326. Database access module 322 enables life-career management system 102 (FIG. 1) to store data in database 114 (FIG. 1).

Data extraction module 324 enables life-career management system 102 (FIG. 1) to retrieve and extract data from web pages and other data sources. For instance, data extraction module 324 may use one or more data harvesting scripts (also referred to as screen scraping scripts) to retrieve data from a web page or other data source. Data harvesting (or screen scraping) is a process in which data is retrieved from one or more web pages associated with web site(s) 110 (FIG. 1). The retrieved data may be stored in a database, such as database 114 (FIG. 1) or other storage mechanism.

Account module 326 enables life-career management system 102 (FIG. 1) to manage account data associated with individuals that access life-career management system 102 including passwords, access information, and various other information associated with individuals' accounts.

Modules 310, 312, 314, 315, 316, 318, and 320 of life-career module 113 shall now be described in more detail.

Exemplary Navigation

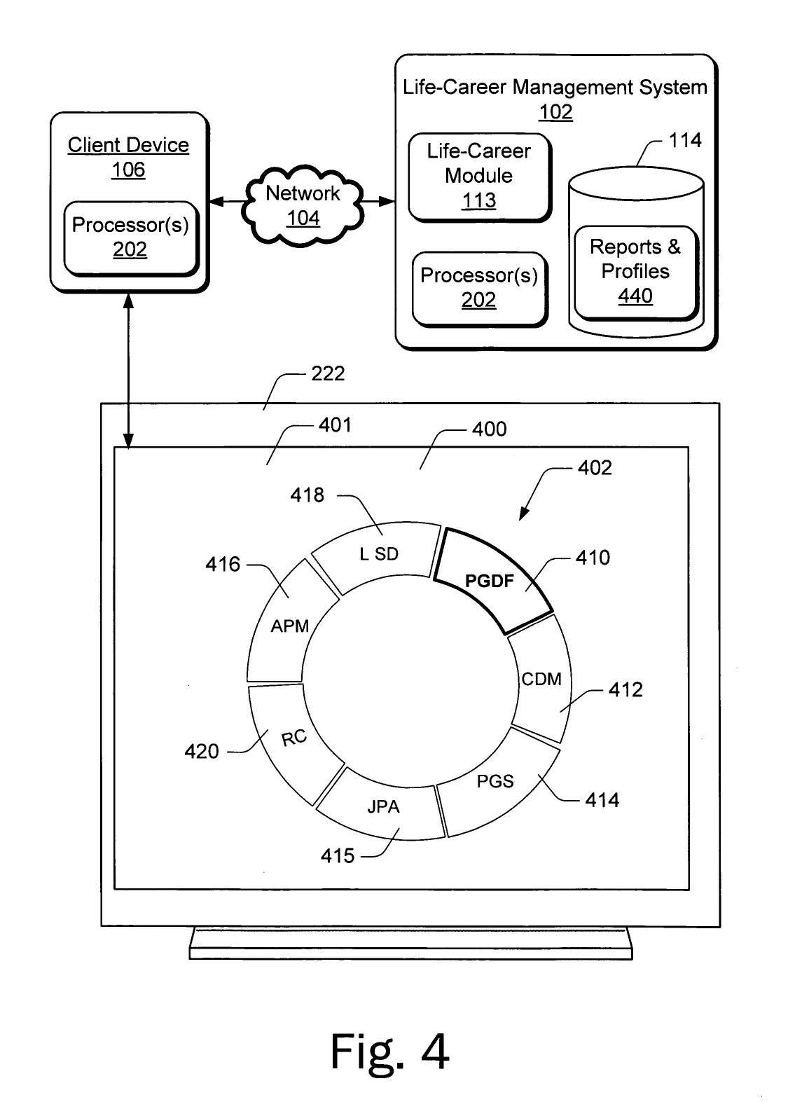

FIG. 4 illustrates a portion of user interface control panel 400 rendered in a display region 401 of display device 222 of a client device 106 by life-career management system 102 executing computer software instructions (i.e., logic) associated with life-career module 113.

Control panel 400 includes a navigation wheel 402 containing selectable icons 410, 412, 414, 415, 416, 418, 420, which enable an individual to navigate between modes of operation rendered on their client device 106 by life-career management system 102, which are facilitated by modules (310, 312, 314, 315, 316, 318, 320) comprising life-career module 113.

When an individual “selects” a particular selectable item, such an icon 410, 412, 414, 415, 416, 418, or 420, the icon contains a hypertext link to a particular page that performs operations associated with the particular item (icon). A page or a set of pages can contain or link to a variety of resources, including images, text, scripts, links to resources and so forth.

An individual may select an item by clicking on the item, which links them to a desired page or causes a task to occur. Clicking may be accomplished through the use of input devices, such as a pointing device, a mouse, joy stick, key board, remote control device, touch-screen, voice activation, or by some other device configured to function with a client device 106, which enables inputs to be entered and ultimately transmitted from the client device 106 to a server 108.

Control panel 400 forms part of a user interface that allows a user to interact with web pages using a browser, such as Microsoft's® Internet Explorer, operating on a client device 106. Content from server 108 (FIG. 1) may be accessible through industry standard Web protocols, such as Extensible markup language (XML), hypertext transport protocol (HTTP), and so forth.

For instance, selecting Personal Growth and Development and Facilitator (PGDF) icon 410, of navigation wheel 402, causes a mode of operation corresponding with personal growth and development module 310 to be rendered by life-career management system 102 on a user interface (on display device 222) of client device 106.

Selecting Career Development Module (CDM) icon 412 causes a mode of operation corresponding with career development module 312 to be rendered by life-career management system 102 on a user interface on display device 222 of client device 106.

Selecting Planning and Goal Setting (PGS) icon 414 causes a mode of operation corresponding with planning and goal setting module 314 to be rendered by life-career management system 102 on a user interface of client device 106.

Selecting Job Procurement Assistant (JPA) icon 415 causes a mode of operation corresponding with job procurement assistant module 315 to be rendered by life-career management system 102 on a user interface of client device 106.

Selecting Achievement and Performance Monitoring (APM) icon 416 causes a mode of operation corresponding with achievement and performance monitoring module 316 to be rendered by life-career management system 102 on a user interface of client device 106.

Selecting Life Skills Development (LSD) icon 418 causes a mode of operation corresponding with life skills development module 318 to be rendered by life-career management system 102 on a user interface of client device 106.

Selecting Life and Career Resource Management Center (RC) icon 420 causes a mode of operation corresponding with career management support and advisory module 320 to be rendered by life-career management system 102 on a user interface of client device 106.

It is appreciated that various other types of icons and means for navigating between web page content produced by life-career module 113 is possible, and navigation wheel 402 is only one of many examples of such navigation means.

Exemplary Personal Growth and Development Module

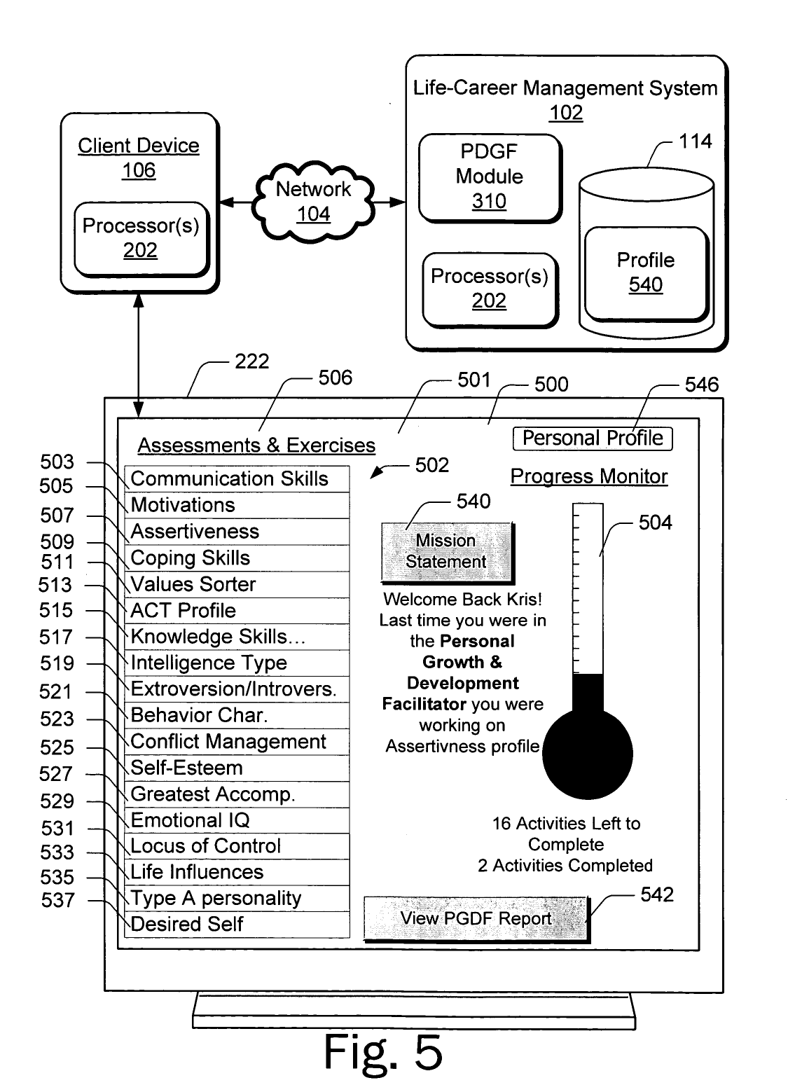

PGDF icon 410 selects a mode of operation rendered by life-career management system 102 (FIG. 1), which is facilitated by personal growth and development module 310. For example, FIG. 5 shows an exemplary page of a control panel 500 displayed in a display area 501 of a user interface display device 222 on a client device 106, which is rendered by life-career management system 102 when in a mode of operation controlled by personal growth and development module 310.

Control panel 500 includes an assessment and exercise section 506 containing hypertext links 502 to a series of personality tests and introspective exercises. Clicking on each link accesses, and thereby enables the individual to access and complete each individual assessment and exercise.

Control panel 500 also includes a progress monitor 504, which shows an individual's progress as the individual completes various activities, exercises, assessments, and tests. In the exemplary illustration, the progress monitor 504 is in the form of a thermometer, but any suitable progress monitors could be used such as a rising bar, pie chart, graph, meter, or other progress monitoring mechanisms.

Additional tool bars, icons, buttons, navigation mechanisms, and information may be displayed in one or more display regions (or separate Web pages) of control panel 500. For example, in one implementation, the navigation wheel 402 (FIG. 4) is displayed in another display region (not shown in FIG. 5) of control panel 500 to enable an individual to switch between modules.

Personal growth and development module 310 is configured to allow an individual to take a series of personality tests, psychological assessments and introspective exercises from assessment and exercise section 506. These tests, assessment instruments, and introspective exercises identify interrelationships, patterns, consistencies and inconsistencies among various distinguishing thought—feeling and behavioral characteristics including: extroversion, agreeableness, conscientiousness, openness, coping and well-being, values, interests, motivations, talents, abilities and learned skills.

The individual can take the introspectively stimulating series of psychological assessments, personality tests, and introspective exercises in response to prompts. Overtime the life and control management module 310 can conveniently construct, and record, a dynamic personal growth and development profile 540 (typically stored in one or more databases 114) about an individual that provides a clear, psychometric self-portrait together with a comprehensive yet flexible, life-career plan to support intelligent life and career decision-making.

In an exemplary implementation, there are 11 online personality assessments that when completed produce 12 separate reports, which are recorded as part of a particular individual's comprehensive profile 540, which may be stored in database 114.

The following is brief summary of personality assessments (linked by hyperlinks) offered to an individual according to an exemplary implementation. Clicking on the hyperlink name associated with the name of the type of test enables pages of that particular test to be automatically presented to the individual. The tests include a communication skills test 503, an emotional intelligence test 529, self-esteem test 525, assertiveness test 507, a coping skills test 509, ACT profile 513, locus of control & attribution style test 531, conflict management test 523, intelligence type test 517, extroversion/introversion test 519, and Type A personality test 535. Alternatively, various other personality tests may be administered, and one or more of the aforementioned tests may be omitted from the battery of tests.

Communication skill test 503 determines interpersonal communication skills ability of the individual. Emotional intelligence test 529 evaluates several aspects of an individual's emotional intelligence. Self-esteem test 525 evaluates a general level of self-esteem of an individual. Assertiveness test 507 measures whether an individual is able to formulate and communicate opinions and wishes in a clear, direct and non-aggressive way. Coping skills test 509 determines how an individual handles stressful situations. ACT profile test 515 measures an individual's personality and the impact their personality will have on their ability to be an effective and satisfied as a working professional. Locus of control and attribution style test 531 assesses locus of control orientation and attribution style. Conflict management test 523 assesses an individual's conflict management style in several areas of their life. Intelligence type test 517 assesses specific sets of strengths and interests. Extroversion/introversion test 519 assesses whether an individual falls within the extrovert or introvert domains. Type A personality test 535 evaluates whether an individual displays Type A, Type B, or Type C behavior.

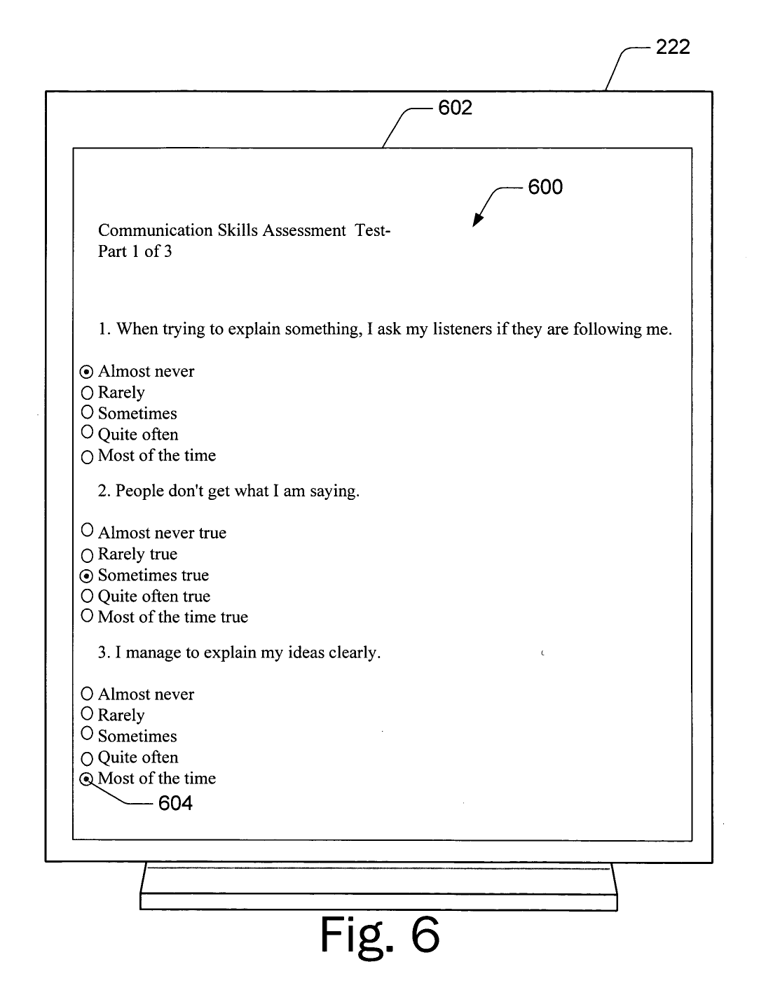

FIG. 6 shows an exemplary format 600 of a personality test displayed on a user interface of a display device 222 of a client device 106 (FIG. 1), when the individual clicks on communications skills hyperlink 503 (FIG. 5) in control panel 500 (FIG. 5). In this example, the first three questions from a page 602 of a communication skills test are illustrated. According to this implementation, the test consists of a series of multiple choice questions that can easily be answered by clicking on the appropriate radio button(s) 604, or other various selectable items. Alternatively, the test may consist of true/false questions, matching schemes, and various other testing presentation formats that can be offered on-line.

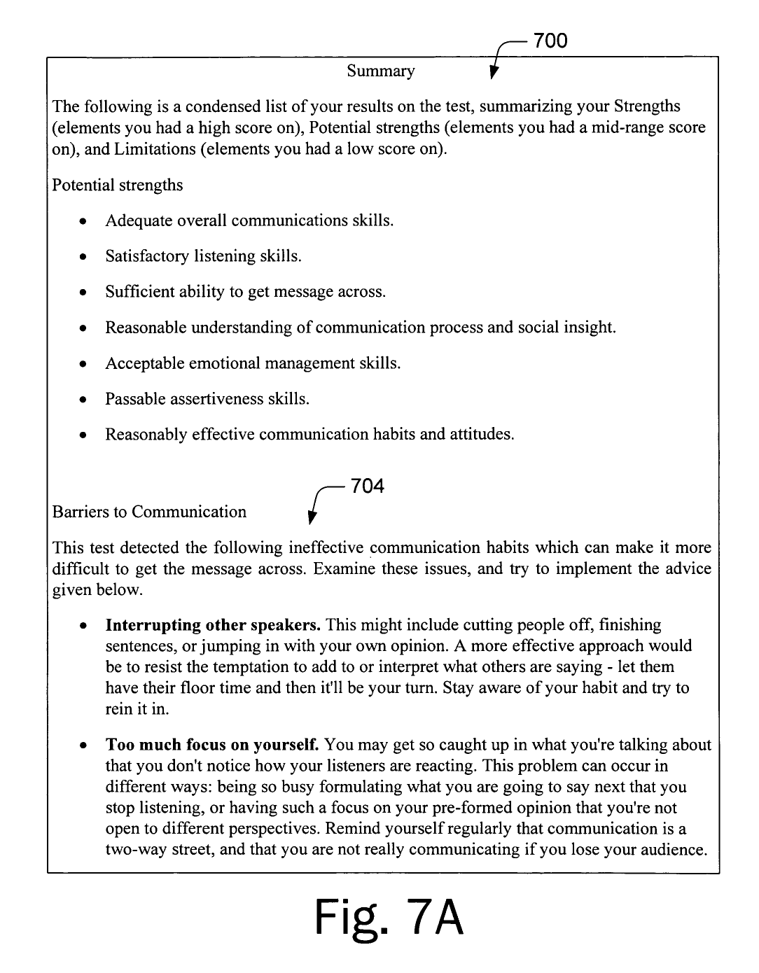

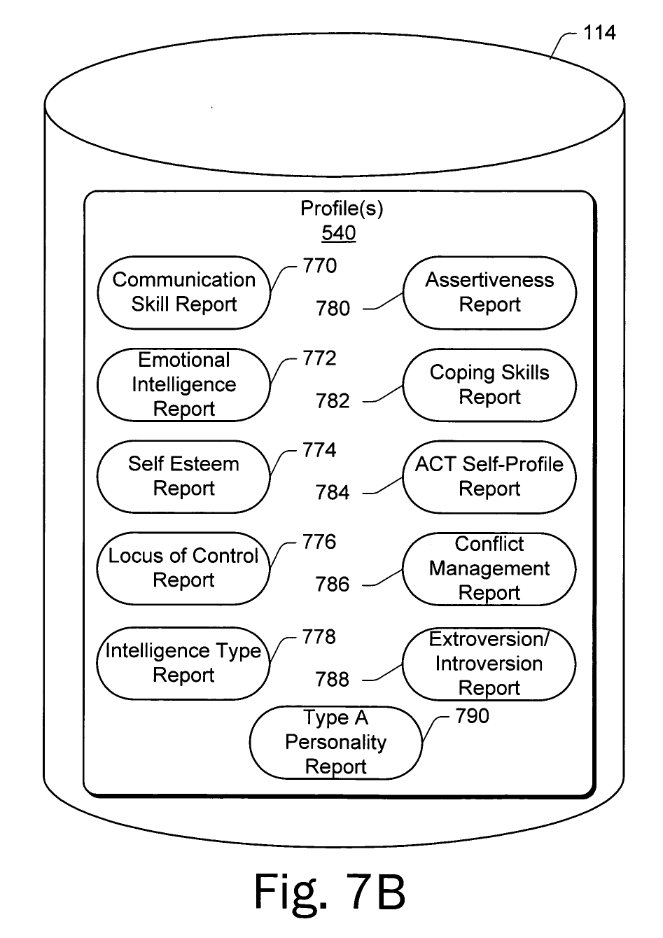

Once each test (assessment) is completed, the results are recorded in a comprehensive profile 540, and an interpretive report may be sent to the individual interpreting the results of the particular tests. For example, FIG. 7A shows a portion 700 of a multiple page communications skills summary report presented to the individual which can be presented in a Web-based online format, electronic message (such as e-mail), and/or as a printed document. Each report, such as a communication skills report 770, may include a section providing helpful tips and advice on how to improve various skills assessed by the tests. For example, portion 700 may include advice and tips 704 on how to avoid barriers to communication.

FIG. 7B shows types of assessment reports that are recorded and electronically disseminated to the individual after completion of each personality assessment. These reports can be presented in a Web-based online format, electronic message (such as e-mail), and/or as a printed document. They include: a communication skills report 770, an emotional intelligence report 772, a self esteem report 774, a locus of control report 776, an intelligence report 778, an assertiveness report 780, a coping skills report 782, an ACT Self-Profile report 784, a conflict management report 786, an extroversion/introversion report 788, and a type A personality report 790.

The communications skills report 774 is generated from a test associated with communication assessment skills test icon 503 (FIG. 5). In one implementation, a nine-page summary with the individual's overall rating on a Communication skills Index between 0 and 100 is provided in the report. The report includes score breakdowns on six communications sub indexes, strengths, potential strengths, barriers to communication, and advice and tips on how to build and practice communication skills.

The emotional intelligence report 772 corresponds to the test associated with the emotional IQ test icon 529 (FIG. 5). In one implementation, a seven-page report indicating a current emotional IQ on an overall basis and on three sub-scales provided in the report. Scores are supplemented with a discussion on what the scores mean, strengths, potential strengths, limitations and advice and tips on how to increase your emotional IQ.

The self esteem report 774 corresponds to the test associated with the self-esteem icon 525 (FIG. 5). In one implementation, the report provides a seven-page overview of the individual's self-esteem measured primarily on an overall index between zero and 100 including a discussion of seven sub index scores and tips for building and keeping high self-esteem.

The locus of control report 776 corresponds to the locus of control test icon 531. In one implementation, the report provides a six-page overview describing the individual's focus of control orientation and attribution style. An overall score is presented together with an interpretation and supported with two sub scores on success and failure attribution. Advice and tips are also provided.

The intelligence type report 778 corresponds to the test associated with the intelligence type icon 517. In one implementation, the report is based upon a Harvard University professor of education Dr. Howard Gardner's theories on multiple intelligence types. Gardner's theories focus on determining: “How am I smart” rather than traditional I.Q. testing that attempts to determine: “How smart am I?” Findings are presented on an overall basis and supported by scores on seven different types of intelligence levels ranging from Bodily Kinesthetic to Interpersonal Intelligence. A description of each intelligence type is offered together with common capacities, strengths, likes and interests of people having each intelligence type.

The assertiveness report 780 corresponds to the test associated with icon 507. In one implementation, the report provides a summary of the individual's overall assertiveness score combined with discussion on three sub scores. Observations on the individual's assertiveness strengths are included together with a discussion on the meaning of assertiveness, as well as helpful advice and tips.

The coping skills report 782 corresponds to the test associated with coping skills icon 509. In one implementation, the coping skills report 782 provides details on coping and dealing with stress. It provides meaning to an overall coping score and commentary on seven sub scores, strengths, potential strengths and how the individual can improve their coping skills.

The ACT self-profile report 784 corresponds to the test associated with ACT profile icon 513. In one implementation, the ACT profile report is a comprehensive 18-page report on the individual's personality. It presents an overall score and rates the individual's personality on 11 sub-scales including a brief commentary. The report also includes circumplex graphics illustrating all 11 of an individual's personality scores on a percentile basis. Additionally, the report includes words and phrases that describe the individual, their work orientation and suggestions for dealing with stress.

The conflict management report 786 corresponds to the test associated with the conflict management icon 523. In one implementation, it presents an extensive 19-page report reviewing conflict management and reflecting on the individual's conflict style on an overall basis and on seven sub-scales. Scores are then evaluated on three levels of social interaction and on high charge, moderate charge or low charge situations. A commentary on the individual's predominant conflict management style together with other styles is presented together with advice, tips and suggestions on how to deal with other people's social styles.

The extroversion/introversion report 788 corresponds to the test associated with the extroversion/introversion icon 519. In one implementation, the report provides an overall score ranging from introvert to extravert, and includes a commentary on what the score means.

The Type A personality report corresponds to the test associated with the Type A personality icon 535. In one implementation, an eleven page report illustrating the individual's general score on a scale ranging between type “C” and type “A” personalities is provided. The report also gauges personality on ten measures. A discussion on the overall score is presented as well as a synopsis on each sub score. Following a summary of the results, tips for transforming a type “A” personality are provided.

In FIG. 5, control panel 500 also includes hypertext links 502 to a series and introspective exercises. Clicking on each link accesses and enables the individual to complete each introspective exercise. In one exemplary implementation, there are seven online introspective exercises that when completed produce information which is recorded as part of a particular individual's comprehensive profile 540, which may be stored in database 114. Contrary to multiple choice questions, these exercises challenge the individual to respond to though provoking questions, that penetrate and unmask hidden aspects of the individual's personality that may are not readily be apparent on a conscious level.

The following is brief summary of introspective exercises shown as hyperlinked icons offered to an individual according to an exemplary implementation. These include a major life influences exercise 533, a personal values sorter 511, a behavioral characteristics exercise 521, a knowledge, skills, talent & passions exercise 515, a motivations exercise 505, a greatest accomplishment exercise 527, and a desired-self questionnaire 537.

Major life influences exercise 533 requires the individual to answer open-ended questions on the environments, people and personal experiences that have had the greatest influence on their life to date.

Personal values sorter exercise 511 assists the individual in identifying those values that have the greatest influence on their life. The sorter leads the individual through a three-step process of identifying those values that have the greatest influence on their life and the decisions the individual makes everyday. After selecting fifteen values that are major influencers, a second step involves choosing a maximum of five values the individual would never compromise. The final step requires the individual to rank their top five values in order of importance resulting in a clear definition of the most influential values of their life.

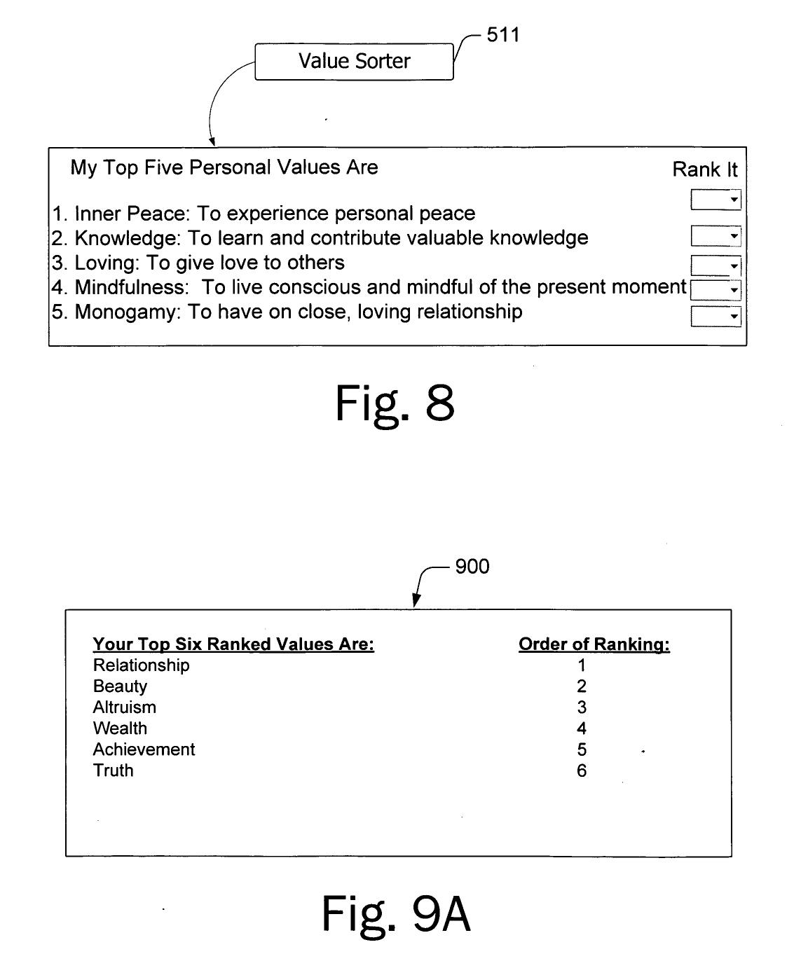

FIG. 8 illustrates one example of the types open-ended questions asked with respect to the introspective exercises presented on a user interface. These questions correspond to the final step of the personal values sorter exercise, launched by clicking on the Value Sorter icon 511 (FIG. 5), and is one example of the type of open-ended introspective questions used in conjunction with the introspective exercises.

Behavioral characteristics exercise 521 requires the individual to identify their three most prominent personal habits and to explore the consequences of changing these habits. Lastly, the exercise calls upon the individual to outline three action steps to change the one habit that currently affects their life the most.

Knowledge, skills, talent and passions exercise 515 requests the individual to specifically identify their unlearned natural talents and abilities as well as their most learned knowledge and developed skills. The key is developing knowledge, skills, talents and passions into personal strengths that can be applied productively. The concluding section of this exercise involves pinpointing the types of activities that the individual is highly interested in and is able to concentrate on for prolonged periods of time. These activities offer powerful clues on where an individual's passions reside.

Motivations exercise 505, prods the individual to specify exactly what motivates him personally. It also asks the individual to identify the role models he would like to emulate, and those things that the individual would be a proponent of, regardless of the consequences. Within these answers are additional clues about the individual's subconscious, personal motivations.

The greatest personal accomplishment exercise 527 asks the individual to identify their three most significant accomplishments in life, or what the individual would like there most significant accomplishments in life to be. The exercise then challenges the individual to link how the three most predominant talents, abilities and learned skills made or can make those accomplishments possible.

Distinct from all other assessments, the desired-self questionnaire 537 seeks to gauge the individual the individual ultimately desires to become rather than the individual the individual currently is. While the current-self and desired-self are likely to be closely aligned, personal growth and change are inevitable. Consequently, findings from the desired-self questionnaire allow the individual to more clearly see and define who the individual aspires to become for the purpose of supporting meaningful growth. Separated into sections, the desired questionnaire spans topics ranging from individual characteristics to talents and skills, values, beauty, wealth and relationships.

Once each introspective exercise is completed, the results are recorded in a comprehensive profile 540 (FIG. 5) by database access module 322 (FIG. 3) operating in conjunction with personal growth and development module 310, and a report may be generated for the individual to access summarizing the results of each particular exercise.

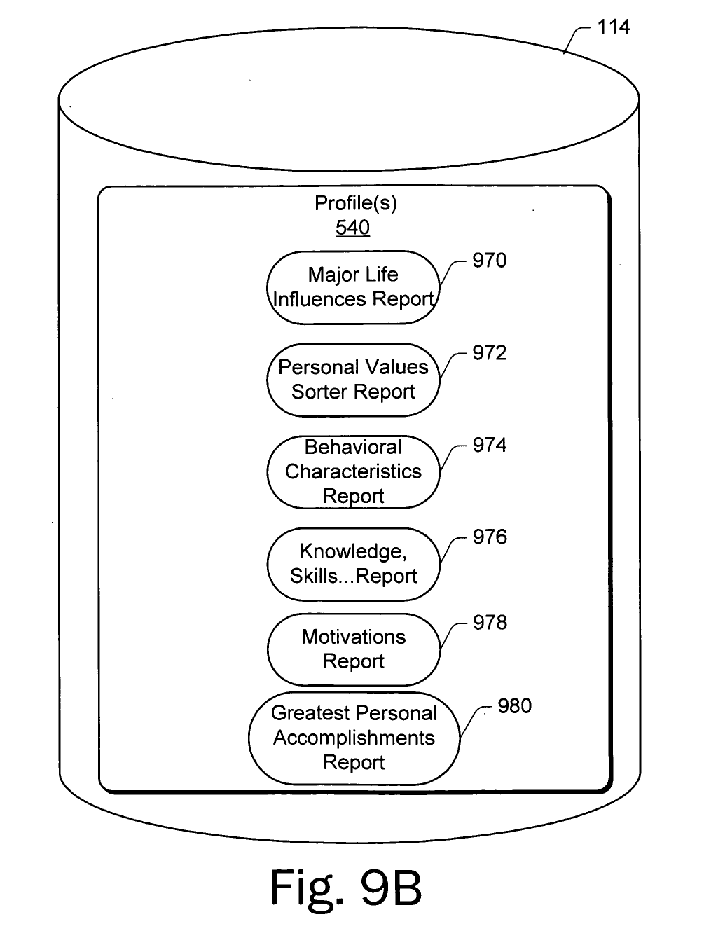

For example, FIG. 9A shows a summary report 900 summarizing results from the desired-self questionnaire introspective exercise which can be presented in a Web-based online format, electronic message (such as e-mail), and/or as a printed document. Along with report 900 there may be an explanation of the findings and ways for the individual to use the information to improve their self, and to keep in mind when encountering life and/or career decisions.

FIG. 9B shows types of assessment reports that are recorded and disseminated to the individual after completion of each introspective exercise, which can be presented in a Web-based online format, electronic message (such as e-mail), and/or as a printed document. They include: a major life influences report 970, a personal values sorter 972, a behavioral characteristics report 974, a knowledge, skills, talents, and passions report 976, a motivations report 978, and greatest personal accomplishments report 980.

Conflict major influences report 970 corresponds to the exercise associated with life influences exercise icon 533. In one implementation, this report provides a summary of the three top environmental, people and personal experiences that have had the greatest influence on the life of the individual.

The personal values sorter report 972 corresponds to the exercise associated with values sorter icon 511. In one implementation, this report provides a distillation of 39 values into those values that are most important personally to the individual.

The behavioral characteristics report corresponds to the exercise associated with the behavior characteristics exercise icon 521. In one implementation, this report provides an identification of the individual's three most predominant habits including the life implications of changing these habits and the action in steps that the individual might take that would result in positive life outcomes.

The knowledge, skills, talents, and passions report 976 corresponds to icon 515. In one implementation, the report provides a summary of the most learned knowledge, three most developed skills, three greatest natural talents and description of activities the individual finds totally absorbing.

The motivations report 978 corresponds to the exercise associated with icon 505. In one implementation, the report provides a listing of the three things that motivate the individual the most, supplemented with the personal characteristics of the three role models the individual wishes to emulate and the three most significant causes the individual would stand up and fight for regardless of the consequences.

The greatest personal accomplishments report 980 corresponds to the exercise associated with icon 527. In one implementation, this report provides a summary of the three greatest lifetime accomplishments of the individual together with identification of natural talents, abilities and learned skills of the individual that made them possible.

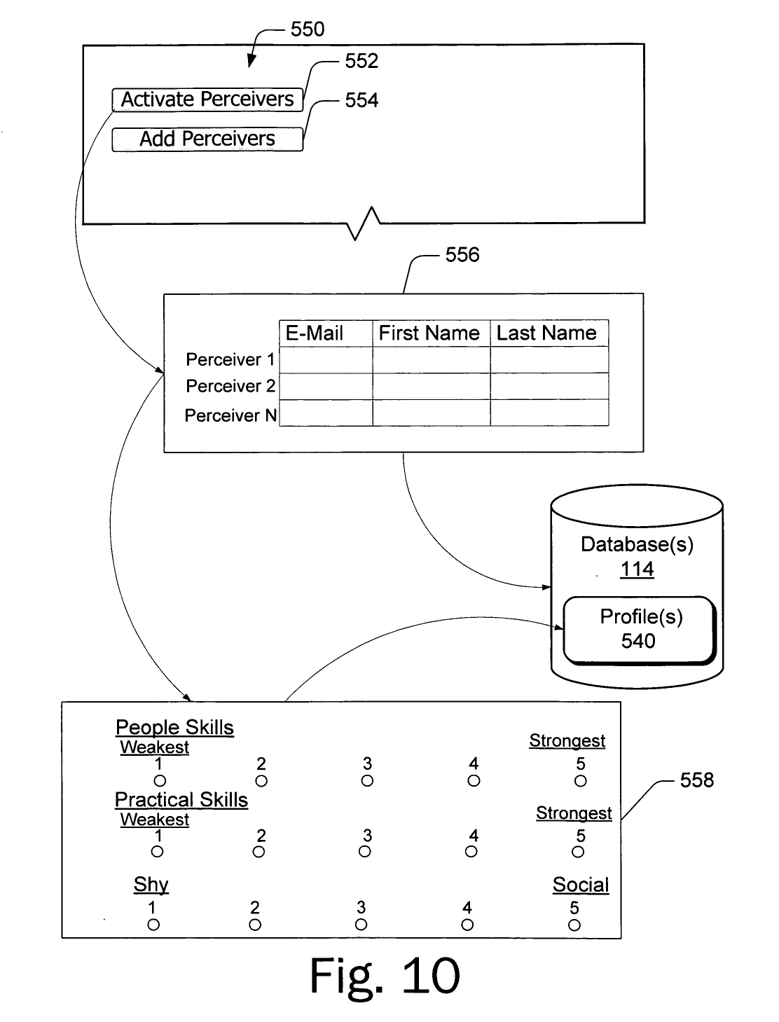

FIG. 10 shows assorted tools produced by personal growth and development module 310 associated with enabling an individual to gather observations and perceptions from others (third party perceivers) about the particular individual automatically.

A first display area 550 includes an add perceiver button 552 and an activate perceiver button 554, both of which contain hyperlinks to other pages, which enable an individual to automatically gather observations and perceptions from others (third party perceivers) about the particular individual. Typically, the information is gathered from friends, family members, co-workers, managers, or other acquaintances that the individual wishes to nominate. For example, clicking on the add perceiver button 552, enables an individual can enter information about a third party perceiver to enable life-career management system 102 to record their information, such as their name and e-mail address, which is saved in database 114. Then by clicking on the activate perceivers button 554 the individual can choose to invite their nominees to participate in providing feedback about the individual automatically via life-career management system 102. Perceivers are then automatically notified electronically, such as by e-mail or by other means, to use the Internet to log on to web-site 110 (FIG. 1) with an assigned identification and password, and to conveniently and anonymously complete a questionnaire.

In one implementation, at least five third party perceivers are required to participate enabling them to anonymously complete a brief perceiver questionnaire (a portion of which is shown in display area 558), which may be hyperlinked to web site 110 (FIG. 1) or contained an e-mail that is sent back to life-career management system 102. Once all the perceivers complete the questionnaires, personal growth and development module 310 algorithmically combines the responses and records a snap-shot of the individual from a perceived-self perspective, e.g., how the individual is perceived by others.

Personal growth and development module 310 blends all the “perceiver” responses to protect the identity of any individual responder and to present a comparison of how the individual is perceived by others in relation to how the individual perceives himself. The snap-shot is then stored by database access module 322 in conjunction with personal growth and development module 310 as part of a comprehensive profile 540.

Referring back to FIG. 5, control panel 500 may also include a personal mission statement icon 542 which contains a link to one or more other pages to enable the individual to enter one or more personal mission statements. For example, FIG. 11 shows a page 1100 in a display area of display device rendered when the individual clicks on the personal mission icon 540 (FIG. 5). Page 1100 includes a text box 1102 and instructional information 1104 to guide the individual when entering their mission statement into text box 1102. The individual may also click on a pop-up window or hypertext link button 1106 to be presented with sample statements to assist the individual when creating their own statement. The sample statements may include: “To dedicate my life to helping people to help themselves,” “To place myself in challenging roles where I can apply my innate people skills dynamically to achieve organizational goals,” “to make a meaningful contribution to world peace” “to become a nationally recognized Wall Street investment banker,” etc. Some of the example statements may adopted by the individual when creating their own mission statement. Once the mission statement is created, the individual can click on a Save & Exit button 1108, and their mission statement is recorded and saved as part of the individual's profile 540 (FIG. 5).

Once the mission statement has been created, the individual may refer to it frequently by clicking on icon 542 (FIG. 5), or by clicking on other icons (to be described) to continually validate whether their current life or career course is consistent with their declaration of whom the individual is and what the individual intrinsically desires to accomplish. The individual may alter their mission statement after it is created to adjust who they are as their life evolves.

Once all the exercises and activities are completed, and the mission statement and third party perceptions are collected by life-career management system 102, the personal growth and development module 310 automatically generates a comprehensive report, sometimes referred to as the Personal Growth & Development Comprehensive Profile Report. That is, the personal growth and development module 310 sifts through, extracts, synthesizes, and integrates all discoveries from the assessment reports (FIG. 7B), introspective exercise reports (FIG. 9B), mission statement (FIG. 11), and optional third party perceiver responses (FIG. 10) to generate the Personal Growth & Development Comprehensive Profile Report (PGDF Report), which can be presented in a Web-based online format, electronic message (such as e-mail), and/or as a printed document.

The PGDF Report's purpose is to connect and tie together important aspects of an individual's individuality extracted from the combination of underlying assessment instruments and introspective exercises. It is intended to present the individual with a “portrait” of their intrinsic-individual personality independent of any particular life role or environment. The objective is to arm the individual with the information, tools and expertise to empower the individual to grow from inside them self instead of from the outside world in.

In one implementation, the PGDF Report is divided into six primary sections: (1) Personality Traits, (2) Coping & Well Being, (3), Skills & Talents, (4) Personal Value System, (5) Conclusions & Suggestions, and (6) Introspective Exercise Summary. Each of the first four sections is further broken down into three or four dimensions to deepen self-understanding and to draw comparisons with normative groups. Interpretations of the results on each dimension, singly and in combination with other scores, will be offered in the narrative text that follows each set of dimensional scores.

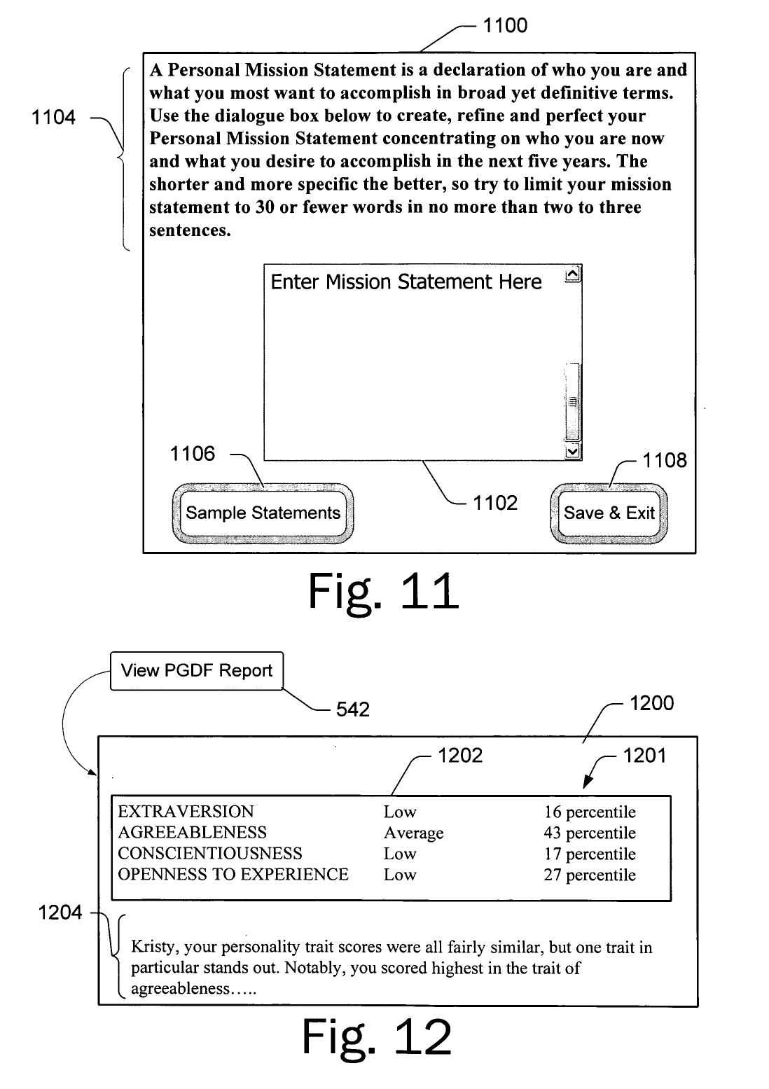

For example, FIG. 12 shows a first portion 1202 of the PGDF Report 1201 dealing with personality traits (section (1)), displayed in display region 1200 of a graphical user interface. The first portion 1202 includes personality trait scores broken into several dimensions. A narrative text section 1204 follows the dimensional scores, providing an in-depth explanation of the results.

Next, within each domain, the results (based on the numerical scores) may be graphically summarized into three dimensions: (1) Current Self—How the individual the views them self currently; (2) Perceived Self—How others view the individual (based on the perceiver responses); and (3) a Desired Self—How the individual would like to be in the future. In other words, the current-self describes what the individual is at the time of completing or updating the personality tests, psychological assessment instruments and introspective exercises. The “perceived-self” describes how the individual is perceived by others on the same scales used to determine the current-self. The “desired-self” describes a person the individual hopes to become in the future. All three views assist the individual through the natural human process of becoming and accelerating personal growth in a purposeful manner.

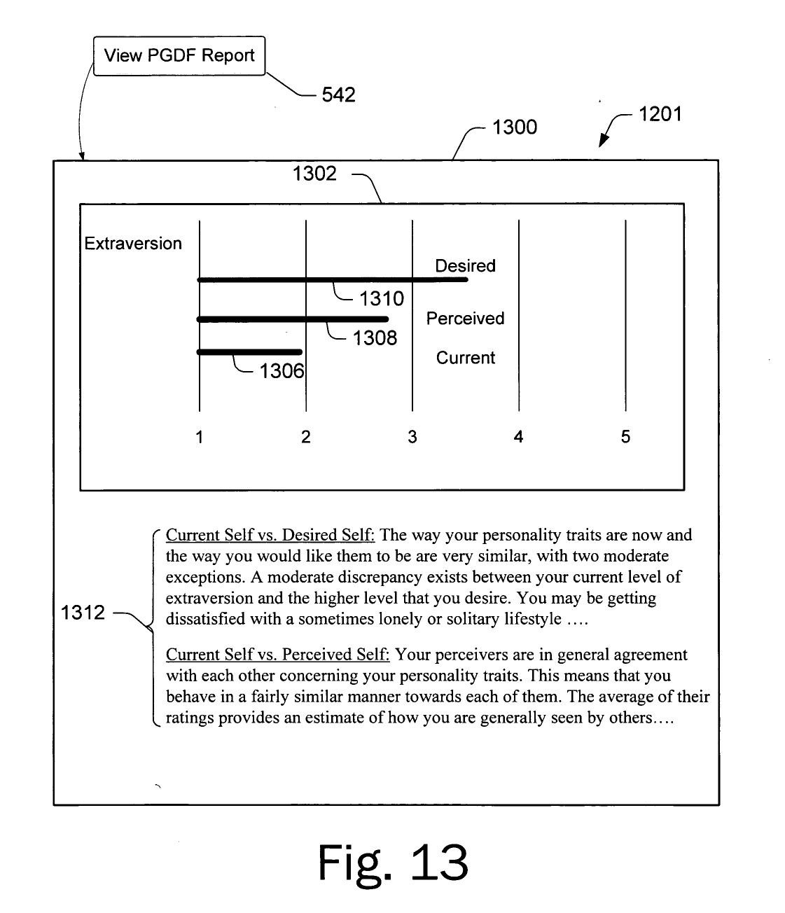

For example, FIG. 13 shows a display region 1300 of a user interface containing a graphical domain summary 1302 summarizing one of the personality traits from FIG. 12 in the three dimensions. For illustration purposes only one personality trait (extroversion) was chosen, but PGDF Report 1201 will typically summarize each trait evaluated in three dimensions. As shown in the graphical domain summary 1302, the individuals extroversion level is illustrated in the three dimensions (i) a current-self 1306, (ii) a perceived-self 1308, and (iii) a desired-self 1310. A five point scale is used in the exemplary illustration, where a five represents the maximum amount of a particular attribute an individual can possess, or more than almost everyone in the population. A four represents an above-average amount of a particular attribute, or more than at least two-thirds of the population. A three represents the average amount of a particular attribute; roughly equal proportions of the population are above and below the individual. A two represents a below-average amount of a particular attribute, or less than at least two-thirds of the population. And a one represents the minimum amount of a particular attribute, or less than almost all of the population.

Interpretations of the consistencies and discrepancies seen in these three distinct views of the individual's authentic self is provided in a narrative text 1312 which follows the graphical domain summary. The graphical domain summary may be illustrated in any number of various graphical methodologies, such as charts, pie charts, and so forth.

PGDP Report 1201 may also include an action plan (not shown) and other information, such as the mission statement and recommendations. Through PGDP Report 1201 an individual can consciously and proactively develop positive distinguishing personality characteristics into strengths that can be referenced and used by the individual in transitioning through life events. PDGP Report 1201 is stored as part of an individual's profile 540 and information contained the report may extracted by other modules for use when assisting the individual in life and career decisions.

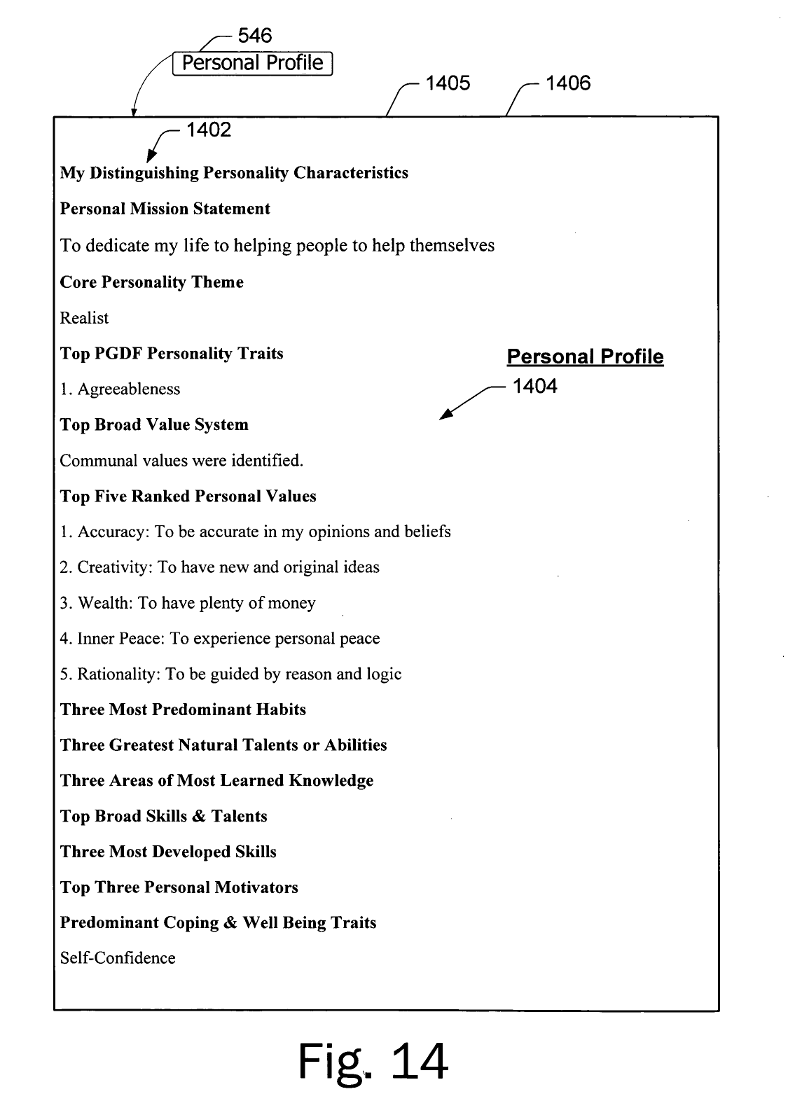

In one implementation, personal growth and development module 310 in conjunction with database access module 322 and data extraction module 324, may populate an abridged version of the PDGP Report, such as a Personal Profile for easy reference by the individual or an advisor. This Personal Profile may be accessed from the control panel, for example, by clicking on an icon associated with the Personal Profile. For example, FIG. 14 shows a section 1402 of a personnel profile 1404 detailing the most significant personality characteristics of the individual extracted from the PDGF Report and other modules. Personal profile 1404 may is displayed as a page 1405 in a display region 1406 of a user interface. Alternatively, it may be disseminated as a printed document. Personal profile 1404 may be accessed by clicking on a personal profile icon 546 (in control panel 500 of FIG. 5). Personal profile 1404 may be accessed at command to aid the individual whenever the individual is planning or contemplating a life/career decision, preparing for an interview or just exploring how to improve their life circumstances. Personal profile 1404 is intended to clarify an individual's thought processes and to aid in the coaching, counseling, and advising process.

Methods for a life-career module 113 may be described in the general context of computer-executable instructions. Generally, computer-executable instructions include routines, programs, logic, objects, components, data structures, and the like that perform particular functions or implement particular abstract data types. The described methods may also be practiced in distributed computing environments where functions are performed by remote processing devices that are linked through a communications network. In a distributed computing environment, computer-executable instructions may be located in both local and remote computer storage media, including memory storage devices.

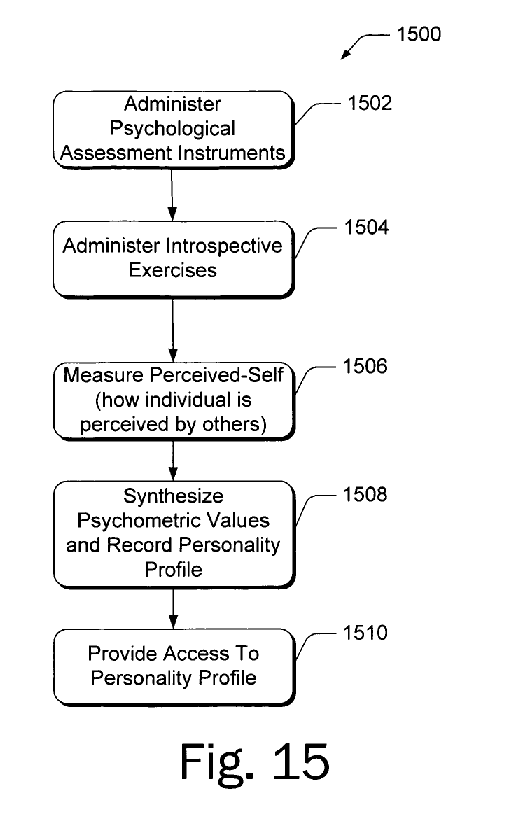

FIG. 15 illustrates a method 1500 to implement functionality associated with Personal Growth and Development Module 310. The order in which the method is described is not intended to be construed as a limitation, and any number of the described method blocks can be combined in any order to implement the method. Furthermore, the method can be implemented in any suitable hardware, logic, software, firmware, or combinations thereof.

In block 1502, psychological assessment instruments are administered to the individual via a Web-based user interface. The instruments provide a psychometric profile of an individual, including traits such as Extroversion, Agreeableness, Conscientiousness, Emotional Intelligence (neuroticism) and Openness. The instruments may measure the individual in two dimensions, a current self and a desired self. Results from each assessment instrument are recorded and stored in a database, and may be presented to the individual in the form of a report upon completion of each assessment.

In block 1504, a series of personal introspective exercises are administered to the individual. The exercises confirm, corroborate and enhance the findings of the psychological assessment instruments. The exercises may measure the individual in two dimensions, a current self and a desired self. Results from each exercise are recorded and stored in a database, and may be presented to the individual in the form of a report upon completion of each exercise.

In block 1506, a series of assessments are administered to third party perceivers of the individual to ascertain how the individual is perceived by others. The anonymity of the third party perceivers' answers may be protected. Results from the perception exercises are recorded and stored in a database, and may be presented to the individual in the form of a report upon completion of the exercises.

In block 1508, one or more portions of the information gathered from the tests, assessments, and exercises described with reference to blocks 1502, 1504, and 1506, are extracted, synthesized, integrated and recorded into a comprehensive personal growth and development report. This report provides a comprehensive “Personality Portrait” of the individual and is intended to serve as a building block for personal growth, career development, job selection, personal and career planning, accomplishing and achieving and life-skills development (including other Life-Career Modules 113).

Additionally, the most significant findings from the comprehensive report (e.g., PDGF Report 1201 (FIGS. 12 and 13)) are extracted and used to create a “Personal Profile” (e.g., Personal Profile 1404 (FIG. 14)) of the individual for quick, convenient recall and reference by the individual and/or advisor whenever the individual is confronted with questions, concerns or issues with any life or career matter. Accordingly, the comprehensive report may be presented in an abridged format.

In block 1510, the individual reports, the comprehensive report, and/or the abridged report are made available to the individual to view or printout over a network, or are made available to advisors. All reports can be updated to enable an individual's personality to be measured overtime.

Exemplary Career Development Facilitator

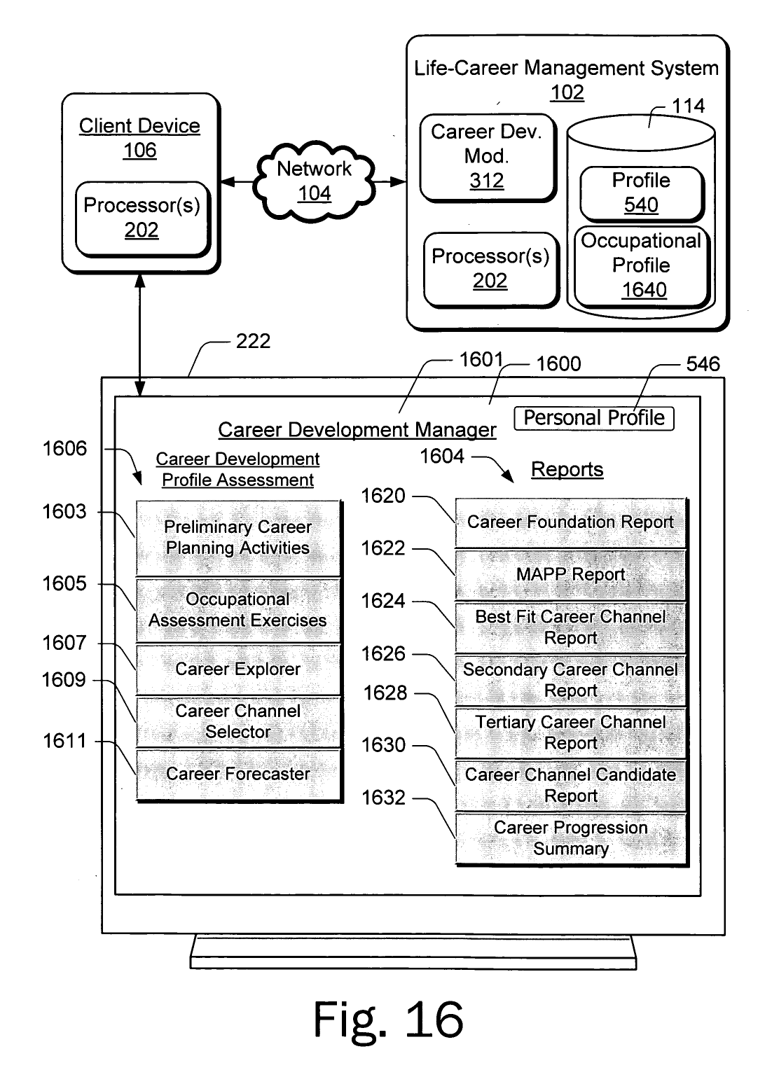

Career development facilitator module 312 (FIG. 3) renders a mode of operation associated with life-career management system 102 (FIG. 1) which displays one or more control panels (to be described with reference to FIG. 16 below) on a user-interface of a client device 106 to automate and simplify career exploration for an individual. Career development module 312 produces a comprehensive set of automated tools to assist the individual in exploring relevant careers, by screening, filtering, and selecting career channels that are best suited to the unique personality characteristics of the individual, and thus creating a foundation for strategic career planning, and purposeful development of the individual's career over the short and long term.

As used herein, “career channel” refers to a generally defined occupational specialty, field and occupational pathway allowing a range of maneuverability within which to make periodic career progression adjustments in accordance with changing personal preferences and environmental conditions. Examples of career channels include: architecture, accounting, communications, engineering, finance, law, health care, marketing, management, production, sales, teaching etc.

Clicking on CDM icon 412 (FIG. 4), in navigational wheel 402 (FIG. 4), selects a mode of operation rendered by life-career management system 102 (FIG. 1), which is facilitated by career development facilitator module 312 (FIG. 3). For example, FIG. 16 shows an exemplary page of a control panel 1600 displayed on a user interface (e.g. display device 222 (FIG. 2)) of a client device 106 produced by career development facilitator module 312. In particular, control panel 1600 is displayed in display area 1601 of a user interface display device 222. Control panel 1600 includes a career development profile assessment section 1606 containing icons 1603, 1605, 1607, 1609, and 1611, each with links to web pages associated with one or more occupational profile assessment instruments and/or career exploration tools. Clicking on each icon enables the individual to access and complete each assessment instrument and utilize the career exploration tools.

Control panel 1600 also includes a report section 1604, which includes icons 1620, 1622, 1626, 1628, 1630, and 1632, and which contain links which permit the individual to access reports summarizing results from the occupational assessment instruments. The reports are accessed from database 114 and provide the individual with career exploration information, career channel nomination, preferred career planning and job procurement advice.

Additional tool bars, icons, buttons, navigation mechanisms, and information may be displayed in one or more display regions (or separate Web pages) of control panel 1600. For example, in one implementation, the navigation wheel 402 (FIG. 4) is displayed in another display region (not shown in FIG. 5) of control panel 1600 to enable an individual to switch between modules.

Referring to career development profile assessment section 1606 and report section 1604, clicking on a preliminary career planning activities icon 1603 links the individual to career exploration, selection, planning and development activities such as: a life role balance evaluator, a work values sorter, an interest profiler, and career status and career dreams questionnaires. The results recorded from completing the combination of these activities generate a personalized Career Foundation Report which is stored as part of an occupation profile 1640 for the individual and/or advisor in database 114, and is accessible by clicking on career foundation report icon 1620. The career foundation report summarizes the individual's unique occupational information and serves as an insightful and invaluable reference source whenever an individual is engaged in career exploration, planning or development activities. It can also be an important aid in preparing for job interviews and in making career related decisions.

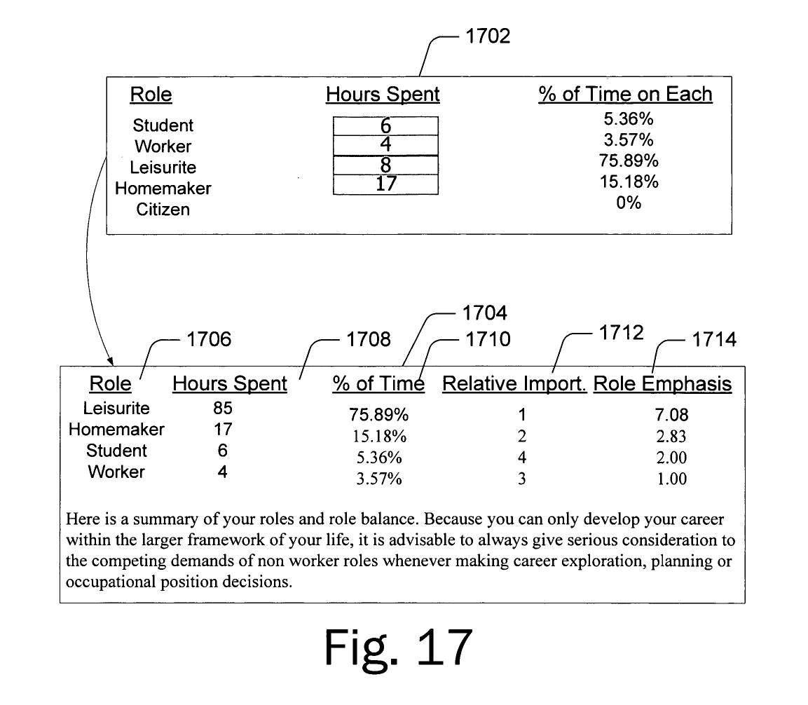

For example, FIG. 17 shows a sample life role balance evaluator exercise 1702 and a portion of Career Foundation Report 1704 produced as a result of completing life role balance evaluator 1702. Life role balance evaluator exercise 1702 is activated by clicking on preliminary career planning activities icon 1603 (FIG. 16). Life Role balance evaluator exercise 1702 helps to identify how the individual plans to invest their time and measures the relative importance the individual places upon competing scientific life roles. The results are stored in database 114.

Career development manager module 310 accesses data recorded in database 114 that is associated with life role balance evaluator exercise 1702 and includes the results of that exercise as part of occupational profile 1640 (FIG. 16), personal profile 540 (FIGS. 5 and 16), and career foundation report 1704. In particular, the portion of career foundation report 1704 associated with the role balance summary illustrates the different life roles 1706 that the individual is engaged in together with the number of hours 1708 and percentage of hours 1710 the individual devotes to each respective role, the individual's subjective role importance weighing 1712, and the overall role emphasis 1714 of the individual's most emphasized role in relation to other competing roles.

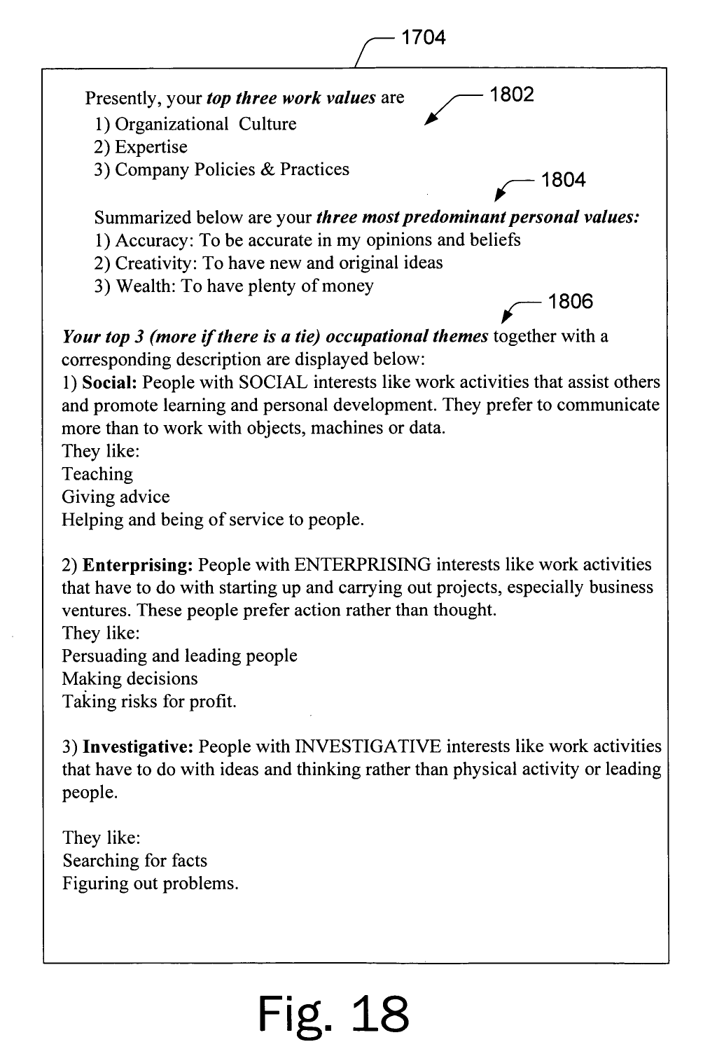

FIG. 18 shows portions of career foundation report 1704, which are associated with other exercises and questionnaires. For example, a work value sorter summary 1802 identifies and ranks the most prominent work related values that have the largest influence on the individual's occupational decisions, actions and behaviors. A personal value summary 1804 presents personal values that were identified by the personal development and growth development facilitator module 310. An occupational interest profile 1806 presents work related interests identified from the interest profiler exercises, which were converted by career development manager module 312 into general occupational themes. Career foundation report 1704 may also provide the individual with top areas within which the individual may begin career exploration, through the use of career categories as identified that interest the individual the most. The individual or a coach/advisor can simply refer back to the report by clicking on career foundation report icon 1620.

In FIG. 16, occupation assessment exercise icon 1605 selects a mode of operation associated with taking and completing a Motivational Appraisal of Personal Potential (MAPP) occupational assessment or similar occupational assessment tools. MAPP is a motivation-based assessment that helps people identify strengths that may be translated into career paths. The results from taking this assessment are stored in database 114 as part of occupation profile 1640. Alternatively, one or more other occupational assessment exercises can be used to identify an individual's strengths and weaknesses, which can then be translated into potential career paths.

The results may be viewed by clicking on a MAPP report 1622 icon, which selects a mode of operation associated with displaying an extensive and comprehensive occupational assessment interpretive report describing and scoring the individual in various areas such as: interest in job content, work temperament, aptitude, how the individual relates to people, things, and data, and capacity for reasoning in mathematics and language. The report also includes commentary and scoring on personality traits, such as leadership, interpersonal, social and performance factors, learning styles, mechanical orientation and major vocational areas concluding in a list of top vocational areas to explore that may have high potential for satisfaction and success.

Career explorer icon 1607 selects a mode of operation associated with presenting top vocational areas identified from the findings of the MAPP report. Career explorer icon 1607 also enables the individual to begin career exploration by viewing career channels identified from MAPP and selecting position titles within each channel. Career explorer icon 1607 enables the individual to use a network to access comprehensive databases of most occupations and specific positions within those occupations. It further enables the individual to compare his distinguishing personality characteristics, interests, abilities, motivations, and skills objectively and subjectively to occupations and positions of his choice to facilitate a logical intelligent career channel selection process. In other words, this allows the individual to filter and intelligently select the highest potential career channel candidates that best fit the personality characteristic and worker trait profile of the individual (some of which was identified from career foundation report 1704). The individual may also review selected career videos to learn more about, confirm and reinforce their career channel selections.

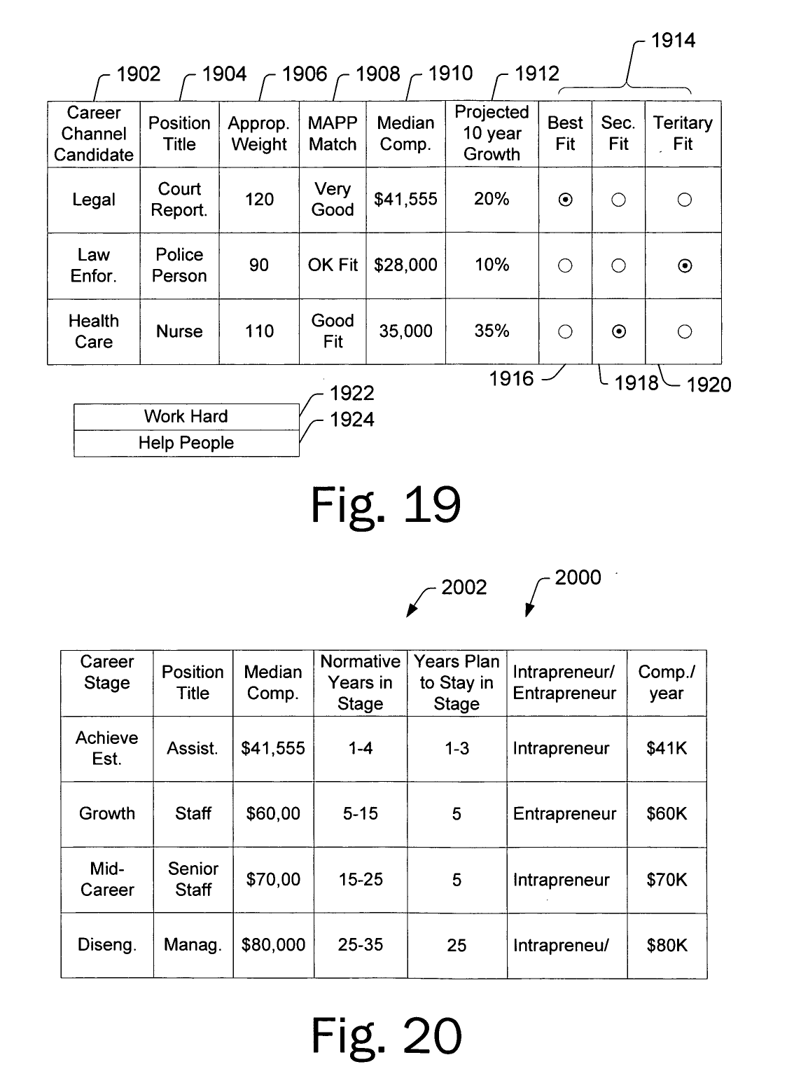

Career channel selector icon 1609 selects a mode of operation associated with identifying career channel candidates and position titles chosen from recorded operations associated with career exploration (career explorer icon 1607). For example, FIG. 19 shows a career channel wizard 1900 that provides a list of career channel candidates 1902, position titles 1904, appropriate weighting 1906, MAPP match classification 1908, median compensation 1910, projected ten year growth percentage 1912, and radio button icons 1914, which allow the individual in selecting a “Best Fit” channel 1916, a secondary fit channel 1918, and a tertiary channel fit channel 1920. An occupational signature theme 1922 and mission statement 1924 recorded from earlier exercises may be displayed to help assist the individual in selecting the career channel candidate that best matches the individual's goals. Results from the wizard are stored as part of the individual's occupational profile 1640 (FIG. 16) and may be retrieved by clicking on career channel candidate icon 1630 (FIG. 16).

In FIG. 16, career forecaster icon 1611 initiates a mode of operation associated with modeling and forecasting a career development progression within the individual's selected preferred or “best fit” career development career channel over an entire career span from career entry through achievement, establishment, growth, maintenance and disengagement. An individual can then visualize the long term implications of a preferred career channel before expending the time, effort and training to pursue it. Results from the forecast are stored in the occupation profile 1640 and may be viewed by clicking on career progression summary icon 1632.

FIG. 20 shows an exemplary career channel progression forecast 2000 of a career over a career span. Career channel progression forecast 2000 includes a table 2002 modeled with the help of a forecasting wizard completed when the individual clicked-on the career forecaster icon 1611. Table 2002 projects a particular career progression over an entire career span from career entry to retirement. Forecast 2000 also highlights the traditional phases of career development, graduated position titles, estimated compensation, years and the individual's age at different career stages (not shown). Career channel progression forecast may also be displayed in other formats such as a graph.

Career development manager is able to generate the progression forecast 2000 based on the individual selecting a position from a list of numerous career positions and the number of years they plan to spend in each stage. Based on this information, it is possible to plot a progression plot with a median of compensation for each position the individual plans to hold at each stage. In one implementation, information such a list of positions and compensation levels are retrieved (by life-career management system 102 via network 104) from an Occupation Network Resource Center (O*NET) database, which is operated by the U.S. Department of Labor, www.onetcenter.org.

In FIG. 16 best fit career channel report icon 1624, secondary career channel report icon 1626, and tertiary career channel report icon 1628, when selected by the individual display a summary report for the position title the individual chose to explore, including a comparison of how the individual's general occupational theme code (from the Interest Profiler) aligns with the theme code ascribed to the position. Each report may also allow the individual to judge how a position may fit with their work related interests. Each report may also contrast the individual's work values to their compatibility with the values ascribed to the position, describe the primary work needs of people who typically hold each position and/or evaluate the working environment, tasks, activities, abilities, skills, knowledge and experience associated with each position.

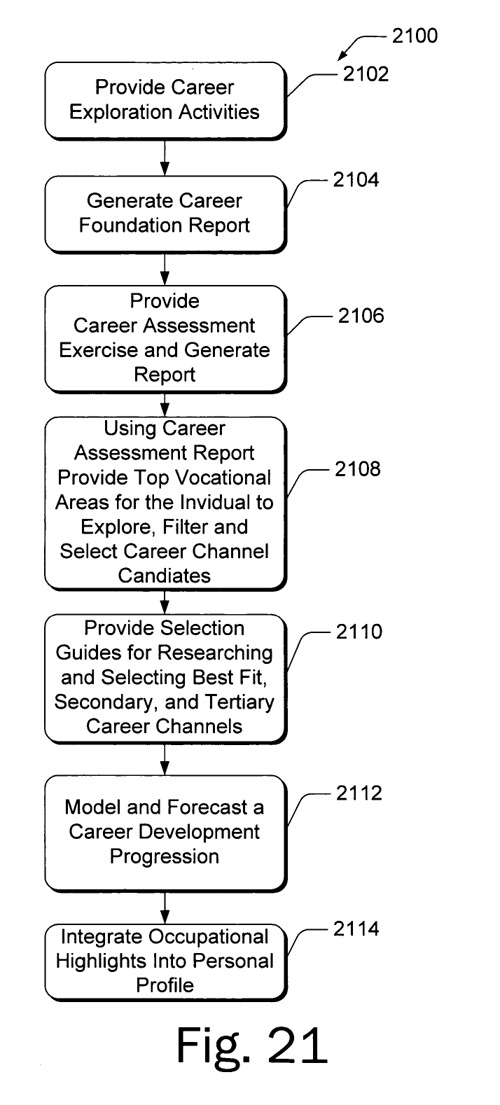

FIG. 21 illustrates a method 2100 to implement functionality associated with Career Development Module 312. The order in which the method is described is not intended to be construed as a limitation, and any number of the described method blocks can be combined in any order to implement the method. Furthermore, the method can be implemented in any suitable hardware, software, logic, firmware, or combinations thereof.

In block 2102, career exploration development and profile assessment exercises are provided to the individual. For example, career development manager 310 provides several on-line exercises to the individual, such as a life role balance evaluator exercise (e.g., FIG. 17), a work values sorter exercise, an interest profiler exercise, and career status and career dreams questionnaires.

In block 2104, the results form the combination of activities performed in block 2102 are extracted and integrated to generate a personalized career foundation report 1704 (see e.g., FIGS. 17 and 18).

In block 2106, a MAPP assessment instrument is provided to the individual to identify various career strengths that may be translated into career paths. The results from taking this assessment are stored in database 114 as part of occupation profile 1640 (FIG. 16) and in the form of a report, which may be viewed by clicking on a MAPP report icon 1622 (FIG. 16).

In block 2108, using data from the occupation assessment exercise (such as gleaned from a MAPP report or equivalent occupational test), top vocational areas are provided to the individual so that the individual may explore, filter, and select career channel candidates. This includes matching interests and strengths from the preliminary career activities, MAPP report, and even personality assessment information generated by the personal growth and development module 310, so as to allow the individual to narrow the field of potential career channel candidates.

In block 2110, guides are provided to the individual to enable the individual to research and select a primary, secondary, and tertiary career channels (see, i.e., FIG. 19).

In block 2112, career development forecasts and career development progression are models are generated. These forecasts may be presented in the form of career progression summary report and may include charts, graphs, and other indicia. In an exemplary implementation, the career progression summary report may be viewed by clicking career progression summary icon 1632. FIG. 20 shows a portion of career channel progression forecast 2000.

In block 2114, information and data produced by method 2100 is stored in a database as part of an individual's occupational profile 1640. Clicking on personal profile icon 546 (FIGS. 5 and 16), causes career development module 312 to render at least a portion of the individual's personal profile associated with career development module 312 to display on a display device 222 of client device 106. The portion of the personal profile associated with career development module 312 may include an occupational highlight section, which includes information and data extracted from occupational profile 1640. The highlights may include an occupational signature theme, an occupation mission statement, a top ranked work related values, occupational personality types, top MAPP personality traits, top worker traits, top learning styles, a best fit career channel, anticipated career channel progression including charts, an occupational role balancer, top vocational areas, top learning styles, a secondary career channel, and a tertiary career channel. These highlights may be accessed by an individual and/or an advisor.

Exemplary Planning and Goal Setting Module

Planning and goal setting are two activities that are generally essential to improving life and career outcomes. Experts agree that performing isn't the problem in people's lives—planning is. Ironically, most people spend more time planning for a vacation or social function than they do in planning their life or career.

Planning and goal setting requires rational thinking and the need to make conscious choices. This is why planning and rational thinking requires taking time out from a busy schedule to make the life choices that are right for the individual. Those choices involve: evaluating existing circumstances, setting appropriate goals, assessing the implications of those goals, and specifying activities to achieve the desired results.

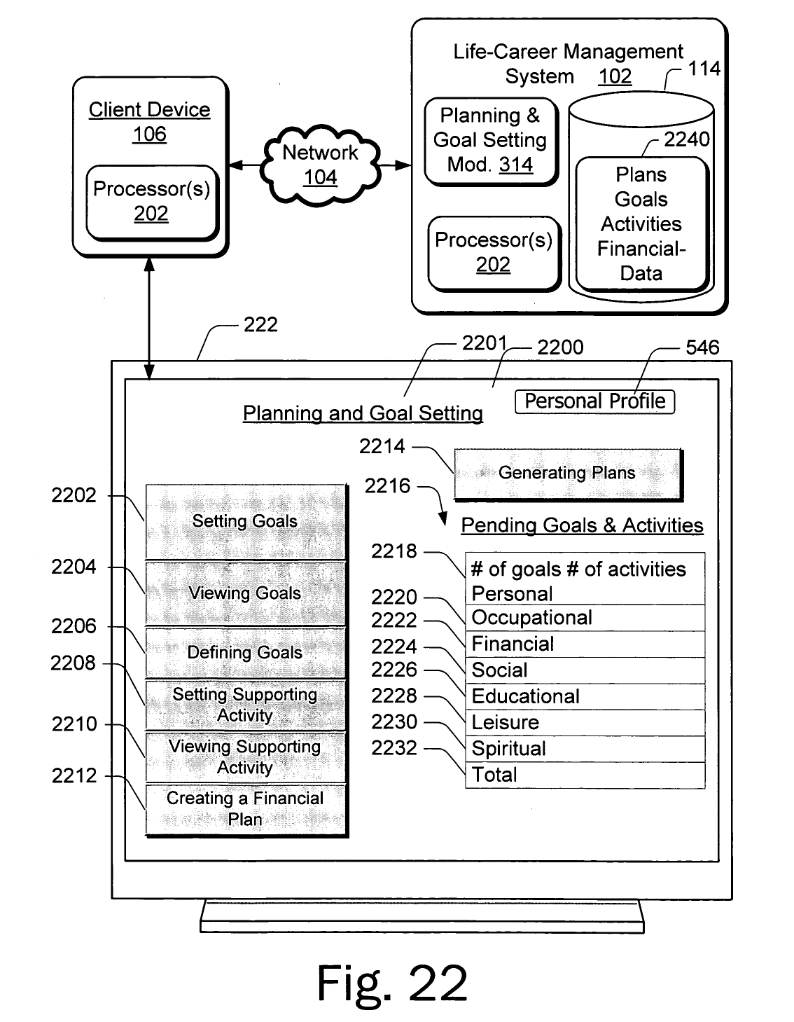

Planning and goal setting module 314 facilitates a mode of operation rendered by life-career management system 102 which displays one or more control panels (to be described with reference to FIG. 22 below) on a user-interface of a client device 106 so as to permit an individual to map out a strategic personal plan to achieve lifetime goals: be it obtaining a corner office, preserving great health, or enjoying wonderful family life. That is, planning and goal setting module 314 provides a mode of operation, rendered by life-career system 102, which organizes, simplifies and automates the planning and goal-setting process for the individual. Through the one or more control panels an individual can complete planning and goal setting module 314, the data from which is recorded in a database 114. Then planning and goal setting module 314 automatically processes the data, and allows the individual to view progress on a daily basis.

Clicking on PGS icon 414 (FIG. 4) in navigational wheel 402 (FIG. 4) selects a mode of operation rendered by life-career management system 102 (FIG. 1), which is facilitated by planning and goal setting module 314 (FIG. 3). For example, FIG. 22 shows an exemplary page of a control panel 2200 displayed on a display device 222 of a client device 106 and produced by planning and goal setting module 314. In particular, control panel 2200 is displayed in display area 2201 of a user interface display device 222.

Control panel 2200 includes a setting goals icon 2202, a viewing goals icon 2204, a defining goals icon 2206, a setting supporting activity icon 2208, a viewing supporting activity icon 2210, a creating a financial plan icon 2212, and a generating plans icon 2214. Each of these icons contains one or more links to web pages associated with personal planning and goal setting processes. Clicking on each icon enables the individual to create, view and record goals including supporting goal elements and activities as well as generating plans, such as financial plans.

As used herein, a goal refers to an end toward with specific efforts are directed, such as a desired and measurable outcome, an aspiration, purpose, intent or intention; a target, and so forth. A personal goal may include choosing what is most important; challenging growth and accomplishment; establishing a life direction; and reducing stress and anxiety, etc.

As used herein, a goal element is an integral part of a goal that influences, supports or possibly hinders the goal's achievement. Goal elements may include strategy, which is the overall approach that is to be employed; people and resources that can assist in achieving goal; rewards and benefits, which is what the goal setter or others will likely realize as a result of accomplishing the goal; and internal and external obstacles, which are barriers standing in the way or obstructing goal achievement

For example clicking on settings goal icon 2202 renders one or more pages in the form of a wizard on display device 222, which allows the individual to enter individual goals within different life arena classifications. The wizard may prompt the individual to select a life arena from one of several choices. As used herein, a life arena is a general classification or subdivision of common areas or categories of life endeavors. In one implementation, there are seven life areas: Personal, Occupational, Financial, Social, Educational, Leisure, and Spiritual. Other categories may also be specified or further sub classified.

Each wizard also provides a series of prompts within which the individual can enter goals, supporting goal elements, and activities to create a plan. The wizard may also request the individual to classify, test and establish targeted achievement dates for each goal they enter.

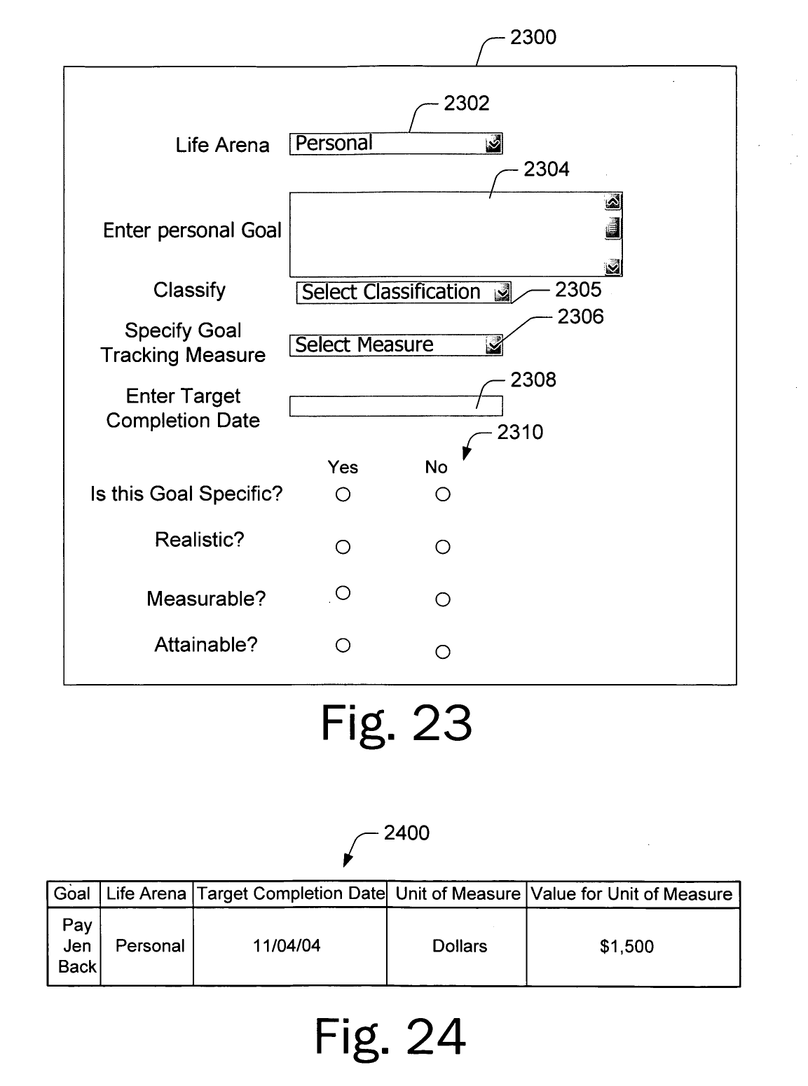

FIG. 23 shows a sample page 2300 (e.g. wizard) rendered on a display device 222 for setting a goal. Page 2300 includes a pull-down box 2302 for selecting the type of life arena, which in the exemplary illustration is in the personal life arena. A list box 2304 is provided for entering a goal, such as getting in better shape, losing weight, quitting smoking, joining a club, and so forth. Page 2300 also includes a pull-down box for selecting a tracking measure, such as units, dollars, percentages. A classify pull-down box 2305 provides a mechanism for classifying the importance of a goal, using such classifications as critical, important or preferred. A date box 2308 allows the individual to enter a target completion date for the goal, which is the specific end date when the goal or activity is expected to be accomplished. Radio icons 2310 force the individual to test their goal to verify its authenticity, by clicking Yes/No in the buttons. To be authentic, the individual must be able to answer Yes for all the criteria. Otherwise, the goal must be modified accordingly. It is appreciated that page 2300 is only one example of the type of information that may be collected, and different indicia may be used to collect the information.

Once the individual has completed entering their goal into page 2300, the individual may then save the data and exit from page 2300 and return back to control panel 2200 in FIG. 22. Setting a goal or activity prompts planning and goal setting module 314 to save the goal or activity in database 114. It also prompts planning and goal setting module 314 to update information displayed in a pending goals and activities section 2216 of control panel 2216 in FIG. 22. Pending goals and activities section 2216 provides a snap shot of how may goals and activities are pending under each life arena category such as Personal 2218, Occupational 2220, Financial 2222, Social 2224, Educational 2226, Leisure 2280, and Spiritual 2230, including a total quantity of goals and activities 2232.

Additionally, once a goal or activity is set, the goal or activity may be viewed by selecting viewing goals icon 2204. For example, FIG. 24 shows a sample portion of a page read from database 114 by planning and goal setting module 314 and displayed to an individual or advisor. Each page may include more than one goal or activity.

In FIG. 22, clicking on Defining Goals icon 2206, produces one or more pages containing input boxes or other tools to enable the individual to enter information by providing a strategy as to how to achieve a goal. For example, the individual may be prompted to input a short concise strategy into a text box (not shown). The individual may also be prompted to identify people and resources that can help the individual achieve the goal. The individual may also be prompted to describe the rewards the individual will gain from completing the goal. The individual may also be prompted to define a personal or organizational obstacle the individual may have to overcome to achieve the goal and how the obstacle may be overcome. Once a goal is defined according to one or more of the aforementioned “goal elements” (e.g., strategy, people and resources, rewards and benefits, and internal & external obstacles), the goal elements are saved as part of planning and goal setting data 2240 in database 114.

It is also possible to view the defined goals by clicking on defining goals icon 2206, which also prompts planning and goal setting module 314 to display the strategies, people and resources, rewards, benefits and obstacles designated as necessary to achieve a goal.

In FIG. 22, selecting Setting Supporting Activity icon 2208, prompts planning and goal setting module 314 to display one or more pages allowing an individual to enter activities needed to accomplish a goal, such as tasks or actions exercised to support of the pursuit of a goal. Clicking on viewing supporting activity icon 2210 prompts planning and goal setting module 314 to display the supporting activities previously entered and retrieved from database 114.

Selecting Creating a Financial Plan icon 2212 prompts planning and goal setting module 314 to display web pages which guide an individual in creating a financial plan. Financial information input by the individual is recorded as part of planning and goal setting data 2240 in database 114. The types of information an individual is prompted to enter include tax information, income, personal expenses, household expenses, transportation expenses, and leisure expenses.

Selecting Plan Generating icon 2214 prompts planning and goal setting module 314 to generate one or more plans based on planning and goal setting data 2240 stored in database 114. Planning and goal setting module 314 collects information associated with planning and goal setting, and transforms the information into an action oriented plan (a roadmap), which may be transmitted and/or viewed in electronic and printed formats. In one implementation, goal setting module 314 produces a personalized comprehensive action plan, a financial plan and a comprehensive action plan.

The contents of an exemplary comprehensive plan include six sections and are as follows:

I.) Living My Life with a Sense of Purpose
I'm Already Different
Purpose—Direction—Focus—Results
Why I Created This Plan
Strategy for Achievement
My Commitment to Implementation

II.) My Personal Characteristics
Personal Mission Statement
Core Personality Theme
Life Role Commitments
Natural Talents & Abilities
Predominant Personal Values
Personal Motivators

III.) Goals—Activities & Goal Elements
Most Critical Goals
Most Critical, Urgent Activities
Personal Goals—Activities & Goal Elements
Social Goals—Activities & Goal Elements
Educational Goals—Activities & Goal Elements
Leisure Goals—Activities & Goal Elements
Spiritual Goals—Activities & Goal Elements

IV.) My Financial Budget & Outlook
Financial Goals—Activities & Goal Elements
Scheduled Income
Personal Expenses
Household Expenses
Transportation Expenses
Leisure Expenses
Assets
Liabilities
Net Worth
Staying Power

V.) My Career Plan
My Occupational Signature Theme
My Occupational Mission Statement
My Occupational Personality Type
My Learned Knowledge
My Marketable Skills
My Predominant Work Values
My Best Fit Career Channel
My Forecasted Career Progression
Occupational Goals—Activities & Goal Elements

VI.) Implementing My Plan
Dreaming & Doing
Remaining Committed
7 Habits of Highly Effective People
MyGuidewire Support
Achievement & Performance Monitoring
Reward Yourself

In one implementation, the financial plan contains four sections to provide a reference document for the individual when personal finances are examined.

Finally, the career plan allows the individual to focus exclusively on their career. The career plan excerpts the first, second, fifth and sixth sections of the Comprehensive Action Plan (see above).

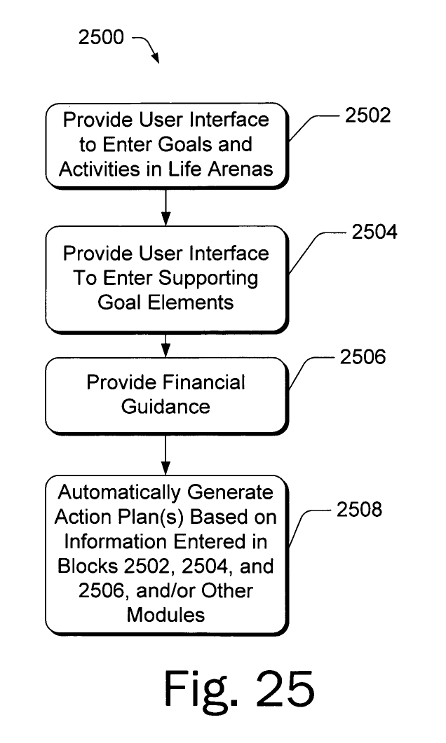

FIG. 25 illustrates a method 2500 to implement functionality associated with planning and goal setting module 314. The order in which the method is described is not intended to be construed as a limitation, and any number of the described method blocks can be combined in any order to implement the method. Furthermore, the method can be implemented in any suitable hardware, logic, software, firmware, or combinations thereof.

In block 2502, a page (in the form of wizards) are presented to an individual enabling the individual to enter goals and/or activities and to classify each goal/activity into life arenas, such as a personal arena, an occupational arena, a financial arena, a social arena, an educational arena, leisure arena and a spiritual arena. This information is recorded in a database

In block 2504, the individual is prompted, via a user interface, to enter supporting goal elements, such as setting overall goal achievement strategy, identifying people and resources that can assist the individual in accomplishing the goal, designating rewards and benefits to achieving the goal, and recognizing internal and external obstacles to achieving the goal. The individual is also prompted to focus on goal supporting activities and to rank activities by importance or urgency. The information is recorded in a database.

In block 2506, the individual is guided, via a user interface, through a financial planning and budgeting process, which includes recording financial and budget related information in a database.

In block 2508, one or more action plans are automatically generated based on information recorded in blocks 2502, 2504, and 2506, as well as select information recorded from other modules. The plans contain an action-oriented roadmap use in assisting the individual to realize their personal, financial and/or career goals.

Exemplary Job Procurement Assistant Module

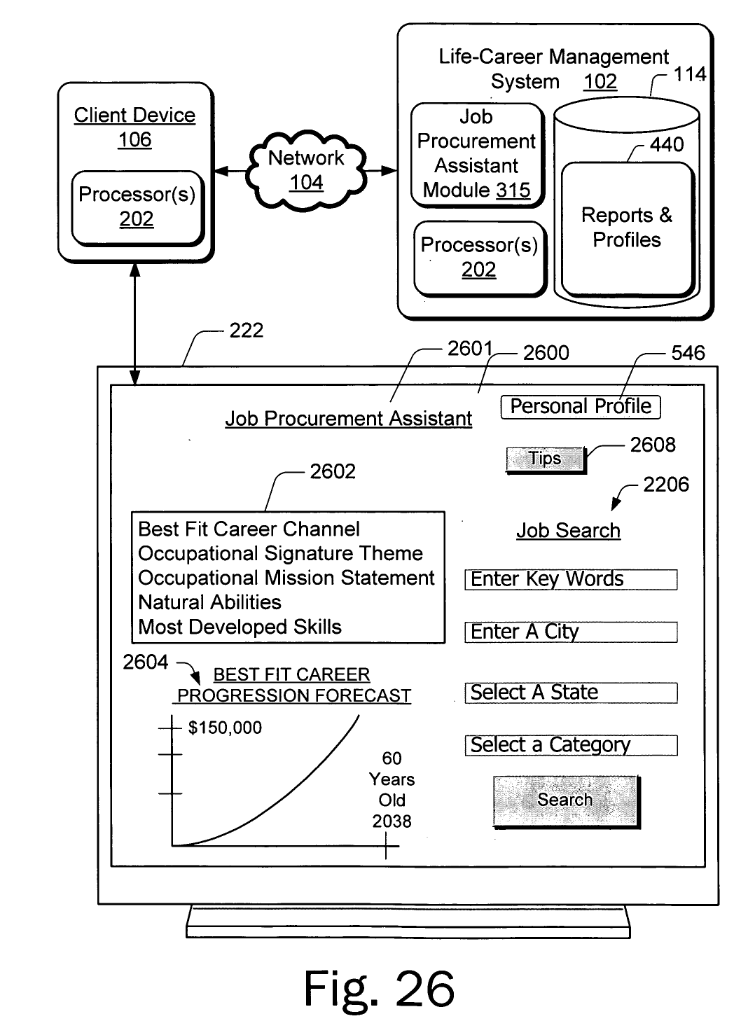

Clicking on JPA icon 415 (FIG. 4) in navigational wheel 402 (FIG. 4) selects a mode of operation rendered by life-career management system 102 (FIG. 1), which is facilitated by Job Procurement Assistant module 315 (FIG. 3). For example, FIG. 26 shows an exemplary page of a control panel 2600 displayed on a user interface (e.g. display device 222 (FIG. 2)) of a client device 106 produced by Job Procurement Assistant module 315. In particular, control panel 2600 is displayed in display area 2601 of a user interface display device 222.

Control panel 2600 includes a job search section 2606 which contains text boxes to enable an individual to enter information for use in screening and identifying job opportunities to view via the user interface. In one implementation, the information that may be entered includes keywords, state location preferences, categories associated with conducting online position searches, and names of companies an individual may have an interest in approaching for employment opportunities. Once the information is entered and a search is performed, job procurement assistant module 315 accesses information from database 114 containing job information and/or Internet sources. In one implementation, current job information is made available through portals built in to job procurement assistant module 315 to CareerBuilder.com, Chicago, Ill., USA and America's Career InfoNet also in Chicago, Ill.

Control panel 2600 also includes a display area 2602 which displays personal characteristics identified and recorded in earlier modules, such as in association with Personal Growth and Development Module 310 and Career Development Module 312, to enable the individual to view those personal characteristics and compare them to the requirements of the positions that they may be considering. Personal characteristics are retrieved from reports and profiles 440 stored in database 114. Such personal characteristics may highlight a best-fit career channel, occupational signature theme, occupation mission statement, natural abilities, and most developed skills. A Best Fit Career Progression Forecast chart 2604 may also be displayed for convenient reference by the individual when searching for a position.

Other tools and indicia may be included in control panel 2600, such as tips button 2608 that when selected enables the individual to gain access to information for assisting the individual in areas such as job interviewing, salary negotiations, resumes, networking, and other related job guidance information.

Exemplary Achievement and Performance Monitoring Module

Achievement and performance monitoring module 316 facilitates a mode of operation associated with organizing, assisting, informing and guiding an individual through the dynamic process of tracking, updating and managing the implementation of life and career plans formulated by career development module 312 and planning and goal setting module 314.

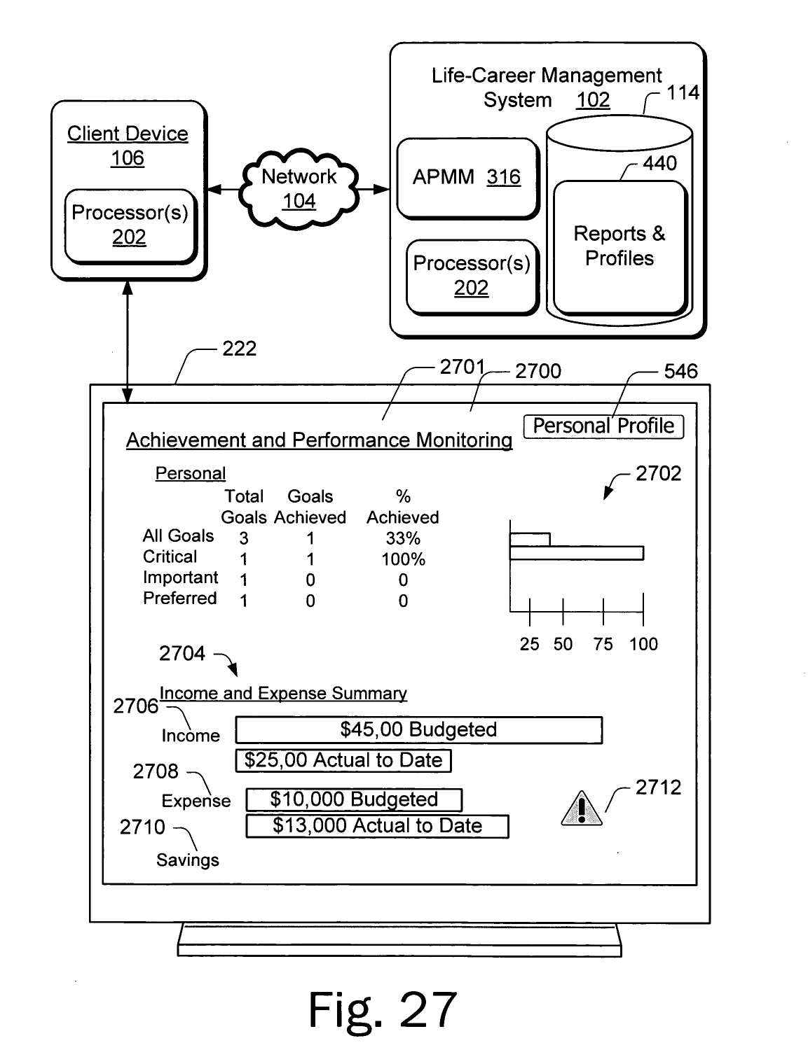

Clicking on APM icon 416 (FIG. 4) in navigational wheel 402 (FIG. 4) selects a mode of operation rendered by life-career management system 102 (FIG. 1), which is facilitated by achievement and performance monitoring module 316 (FIG. 3). For example, FIG. 27 shows an exemplary page of a control panel 2700 displayed on a user interface (e.g. display device 222 (FIG. 2)) of a client device 106 produced by achievement and performance monitoring module 316. In particular, control panel 2700 is displayed in display area 2701 of user interface display device 222.

Control panel 2700 may include one or more goal charts, such as goal chart 2702. Each of the one or more goal charts are classified by life arenas such as the seven life arenas described with reference to planning and goal setting module 314, which includes: Personal, Occupational, Financial, Social, Educational, Leisure, and Spiritual arenas. Each goal chart shows progress towards accomplishing a goal, an activity and/or a financial objective (each goal, activity or financial activity may be viewed and managed separately from each other). For example goal chart 2702 shows the individual's actual performance at a glance towards achieving a critical, an important and/or preferred personal goal as well as achievement progress presented in the form of a graph and percentage to completion of the goal or activity. An individual may use the goal charts and compare these goals with their desired role balance from their personal profile via icon 546 to determine if their actual accomplishments are consistent with their personal priorities.

Additionally, an income and expense summary section 2704 provides the individual an indication of income 2706, expenses 2708, and savings 2710 comparing budgeted amounts to actual to-date amounts. This is intended to allow the individual to make adjustments to reach their financial goals. An alert message 2712 is displayed on the screen if a current amount exceeds a budgeted amount. This alert message 2712 may take many forms and may be transmitted via e-mail or other electronic methods. In the exemplary implementation, bar graphs are used to show the actual to budgeted comparisons, however, equivalent indicia may be used such as graphs, text, and related indicia.

Exemplary Life and Career Management Resource Center Module & Life Skill Development Module

Life skills development module 318 facilitates a mode of operation associated with enabling individuals to learn and develop selected life skills through informative development tutorial information. Clicking on LSD icon 418 (FIG. 4) in navigational wheel 402 (FIG. 4) selects a mode of operation rendered by life-career management system 102 (FIG. 1), which is facilitated by life skills development module 318 (FIG. 3).

Career management support and advisory module 320 facilitates a mode of operation associated with enabling life-career management system 102 to access information recorded and maintained by life-career module 113 in one or more databases 114, and to render informed life and career guidance to individuals through various communication media, such as the Internet, e-mail communications, telephonic communications, voice over Internet protocol (VOIP), video conferencing, and other teleconferencing techniques. Clicking on RC icon 420 (FIG. 4) in navigational wheel 402 (FIG. 4) selects a mode of operation rendered by life-career management system 102 (FIG. 1), which is facilitated by life and career management resource center 320 (FIG. 3).

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method, comprising:
providing an interface to a life and career management control system having life and career management modules;
receiving a first set of information about an individual, from at least the individual, through the interface;
compiling the first set of information into a comprehensive personal profile;
determining distinguishing personal characteristics, career aspirations, life aspirations, and/or financial goals about the individual; and
generating a guidance report and communicating the guidance report via the interface;
wherein the guidance report includes strategies and methodologies to direct the individual when confronted with at least one of a career, financial, and life decision.

2. The method as recited in claim 1, further comprising providing at least a portion of the comprehensive profile to an advisor to assist the individual in making at least one of the career, financial, and life decision.

3. The method as recited in claim 1, further comprising receiving, subsequent to providing the comprehensive profile, a second set of information about the individual, and updating the comprehensive profile.

4. The method as recited in claim 1, wherein the personality assessment exercises assess the individual in at least three dimensions: a current-self, a desired-self, and a perceived-self.

5. The method as recited in claim 1, wherein the life and career management modules include at least one of a personal growth and development facilitator module, a career development manager module, a job procurement assistant module, a planning and goal setting module, an achievement and performance monitoring module, a life skills development module, and life and career management support advisor module.

6. The method as recited in claim 1, further comprising displaying a personal profile display icon on the user interface for reference by the individual when making life and career management decisions, the personal profile display icon displays one or more values most important to the individual.

7. A computer-readable medium comprising computer executable instructions for carrying out the method of claim 1.

8. A life and career management control system, comprising:
life and career management modules configured to (i) receive personal information provided by an individual, (ii) compile the personal information into a comprehensive profile, wherein the comprehensive profile identifies one or more distinguishing personal characteristics, career aspirations, life aspirations, and/or financial goals about the individual; and (iii) provide advice and guidance reports to an individual on a dynamic basis, wherein the advise and the guidance reports include strategies and methodologies to help direct an individual when confronted with at least one of a career, financial, and life decision; and
a user interface, coupled to the life and career management modules, configured to allow an individual to interact with the life and career management modules and to allow an advisor to access the comprehensive profile to assist the individual in making at least one of the career, the financial, and the life decisions.

9. The life and career management control system as recited in claim 8, wherein the life and career management modules comprise a personal growth and development facilitator module, configured to (1) enable the individual to enter personal information about the individual via the user interface wherein some of the personal information includes personal characteristics gathered as a result of the individual participating in personality assessment exercises, and (2) provide a personality profile of the individual contrasting personality traits in at least one of a current-self dimension, a perceived-self dimension, and a desired-self dimension.

10. The life and career management control system as recited in claim 8, wherein the life and career management modules comprise a personal growth and development facilitator module, configured to (1) provide a means for entering personal information about the individual via the user interface wherein some of the personal information includes personal characteristics gathered as a result of the individual participating in personality assessment exercises, and (2) provide a personality assessment report interpreting at least one of the personality assessment exercises.

11. The life and career management control system as recited in claim 8, wherein the life and career management modules comprise a personal growth and development facilitator module, configured to (1) receive personal information about the individual via the user interface wherein some of the personal information includes personal characteristics gathered as a result of the individual participating in personality assessment exercises, (2) receive perceptions about the individual from designated persons identifying personal characteristics about the individual via the user interface, and (3) provide a personality profile summarizing the individual's personality characteristics in a perceived-self dimension based on the perceptions provided by the designated persons.

12. The life and career management system as recited in claim 8, wherein the life and career management modules comprise a career development manager module configured to select information from the comprehensive profile and based on the selected information, identify at least one of a best fit candidate career path, a secondary candidate career path, and a tertiary candidate career path that match the selected information.

13. The life and career management system as recited in claim 8, wherein the life and career management modules comprise a career development manager module configured to automatically project a career path over an entire career span including prospective position titles, period holding each title, and estimated incomes for each title.

14. The life and career management system as recited in claim 8, wherein the life and career management modules comprise a planning and goal setting module configured to enable an individual, via the user interface, to organize a planning process into life arenas comprising at least one of a personal arena, an occupational arena, a financial arena, a social arena, an educational arena, a leisure arena, and a spiritual arena.

15. The life and career management system as recited in claim 8, wherein the life and career management modules comprise a planning and goal setting module configured to automatically rank goals and activities based on the comprehensive profile of an individual.

16. The life and career management system as recited in claim 8, wherein the life and career management modules comprise a planning and goal setting module configured (i) to enable an individual to interact with a goal setting guide which quizzes an individual to ascertain their goals via the user interface, (ii) to automatically rank the goals, and based on their ranking (iii) to generate a comprehensive and personalized action plan for the individual to follow over time.

17. The life and career management system as recited in claim 8, wherein the life and career management modules comprise a job procurement assistant module configured to automatically screen and identify job opportunities for an individual to view via the user interface.

18. The life and career management system as recited in claim 8, wherein the life and career management modules comprise a job procurement assistant module configured to identify job opportunities from one or more Internet sources that are consistent with a career development plan identified with the comprehensive profile.

19. The life and career management system as recited in claim 8, wherein the life and career management modules comprise an achievement and performance module, configured to display to an individual, via the user interface, a control console comprising a display area containing at least one goal chart classified by at least one particular type of goal, wherein the goal chart provides an indication of progress to achieving the one particular goal.

20. The life and career management system as recited in claim 8, wherein the life and career management modules comprise an achievement and performance module, configured to display to an individual, via the user interface, a control console comprising a display area containing a plurality of goal charts each classified by a particular type of goal, including at least one of a personal goal, an occupational goal, an educational goal, a leisure goal, a spiritual goal, and a financial goal, wherein the goal chart provides an indication of progress to achieving the particular type of goal.

21. The life and career management system as recited in claim 8, wherein the life and career management modules comprise an achievement and performance module, configured to display to an individual, via the user interface, a control console comprising a display area containing at financial goal chart, that provides finance and budget information and an indication of progress to achieving the one or more financial goals.

22. The life and career management system as recited in claim 8, wherein the life and career management modules comprise an achievement and performance module, configured to display to an individual, via the user interface, a control console comprising a display area containing at financial goal chart, that provides finance and budget information and displays an alert if an expense exceeds a particular budget level.

23. The life and career management system as recited in claim 8, wherein the life and career management modules comprise a life skills developer module configured to disseminate to an individual via the user interface, educational information associated with improving life skills.

24. The life and career management system as recited in claim 8, wherein the life and career management modules comprise a life and career management support and advisory module, configured to allow an individual to interact with an advisor via the user interface.

25. The life and career management system as recited in claim 8, wherein the life and career management modules comprise a life and career management support and advisory module, configured to enable an individual to select an advisor via the user interface.

26. The life and career management system as recited in claim 8, wherein the life and career management modules comprise a life and career management support and advisory module, configured to enable an individual to access a life and career management resource library via the user interface.

27. The life and career management system as recited in claim 8, wherein the life and career management modules are implemented in a server, and the user interface is implemented in a client, wherein the server is coupled to the client via a data-bearing communication path.

28. The life and career management system as recited in claim 8, wherein the life and career management modules comprise a personal growth and development facilitator module, configured to enable the individual to enter personal information about the individual via the user interface wherein some of the personal information includes personal characteristics gathered as a result of the individual participating in personality assessment exercises and introspective exercises, wherein the introspective exercises focus the individual on at least one personality characteristic.

29. The life and career management system as recited in claim 8, wherein the life and career management modules comprise a personal growth and development facilitator module, configured to enable the individual to enter personal information about the individual via the user interface wherein some of the personal information includes personal characteristics gathered as a result of an individual participating in personality assessment exercises and at least one question used to capture an individual's desired personality characteristics.

30. The life and career management system as recited in claim 8, wherein the life and career management modules comprise a personal growth and development facilitator module, configured to enable an individual to participate in a series of personality assessment exercises via the user interface.

31. The life and career management system as recited in claim 8, wherein the life and career management modules comprise a personal growth and development facilitator module, configured to enable an individual to participate in a series of personality assessment exercises via the user interface, and track progress of an individual in completing the personality exercises in a display area of the user interface.

32. A method, comprising:
enabling an individual to interface with a life and career management control system via a user interface, the life and career management control system configured to provide automated and integrated life guidance, career guidance and financial guidance to an individual to enable the individual to manage and direct their life and career dynamically over time;
enabling an individual to enter personal information about an individual via a user interface, wherein some of the personal information includes personal characteristics gathered as a result of an individual participating in personality assessment exercises via a user interface;
compiling the personal information into a comprehensive profile, wherein the comprehensive profile identifies distinguishing personal characteristics, career aspirations, life aspirations, and/or financial goals about the individual; and
providing a guidance report to the individual via a user interface, wherein the guidance report includes strategies and methodologies to direct the individual when confronted with at least one of a career, financial, and life decision.

33. One or more computer-readable media comprising computer executable instructions that, when executed, direct one or more computers to:
enable an individual to interface with a life and career management control system via a user interface, the life and career management control system configured to provide automated and integrated life guidance, career guidance and financial guidance to an individual to enable the individual to manage and direct their life and career dynamically over time;
enable an individual to enter personal information about an individual via a user interface, wherein some of the personal information includes personal characteristics gathered as a result of an individual participating in personality assessment exercises via a user interface;
compile the personal information into a comprehensive profile, wherein the comprehensive profile identifies distinguishing personal characteristics, career aspirations, life aspirations, and/or financial goals about the individual; and
provide a guidance report to the individual via a user interface, wherein the guidance report includes strategies and methodologies to direct the individual when confronted with at least one of a career, financial, and life decision.

34. A life and career management control system for assisting an individual to manage their life and career, comprising:
life and career management modules, configured to permit an individual to create, modify, update, and actively reference information pertaining to the establishment and improvement of their career and management of their life;
a user interface, coupled to life and career management modules, configured to allow an individual to interact with life and career management modules;
the life and career management modules comprising:
logic configured to enable the individual to take one or more personality tests, psychological assessment instruments, and introspective exercises via a user interface;
logic configured to automatically construct and electronically record a dynamic personal growth and development profile that provides a psychometric self-portrait of the individual constructed from results obtained from the individual taking the one or more personality tests, psychological assessment instruments and introspective exercises; and
logic configured to provide to the individual a comprehensive life and career plan corresponding to the dynamic personal growth and development profile.

35. The life and career management control system as recited in claim 34, wherein the life and career management modules are implemented in a server, and the user interface is implemented in a client device coupled to the server via a data-bearing communication link.

36. The life and career management control system as recited in claim 34, wherein the life and career management modules further comprise logic configured to transmit periodic recommendations and summary overviews of life and career management ideas and techniques targeted to specific needs of the individual, including at least one of (i) occupational opportunities corresponding to the dynamic personal growth and development profile of the individual and (ii) life and career goals developed corresponding to the dynamic personal growth and development profile of the individual.

37. The life and career management control system as recited in claim 34, wherein the dynamic personal growth and development profile is configured to be modified by the individual through interactions with life and career management modules as goals and situations evolve for the individual over a course of a lifetime for the individual.

38. The life and career management control system as recited in claim 34, wherein the personal growth and development profile is a report that identifies interrelationships, patterns, consistencies and inconsistencies among various distinguishing thought, feeling and behavioral characteristics including at least one of: extroversion, agreeableness, conscientiousness, openness, coping and well-being, values, interests, motivations, talents, abilities and learned skills.

39. The life and career management control system as recited in claim 34, wherein the personal growth and development profile is a report described in three dimensions (i) a current-self, (ii) a perceived-self, and (iii) a desired-self, wherein the current-self describes what the individual is at the time of completing or updating the personality tests, the psychological assessment instruments and the introspective exercises, wherein the perceived-self describes how the individual is perceived by others, wherein the desired-self describes a person the individual hopes to become in the future.

40. A method for assisting an individual to manage their life and career, comprising:
enabling an individual to interact with life and career management modules, the life and career management modules configured to permit individuals to create, modify, update, and actively reference information pertaining to the establishment and improvement of their careers while concurrently managing their lives;
enabling the individual to take one or more personality tests, psychological assessment instruments, and introspective exercises via a user interface generated by the life and career management modules;
compiling the information assembled from the one or more personality tests, psychological assessment instruments, and introspective exercises, recording a profile about the individual based on the compiled information, the profile providing a psychometric self-portrait of the individual.

41. The method as recited in claim 40, allowing an advisor to reference the profile via a user interface to guide the individual in making at least one of a career, a financial, and a life decision.

42. The method as recited in claim 40, wherein the profile is a report described in three dimensions (i) a current-self, (ii) a perceived-self, and (iii) a desired-self, wherein the current-self describes what the individual is at the time of completing or updating the personality tests, the psychological assessment instruments and the introspective exercises, wherein the perceived-self describes how the individual is perceived by others, wherein the desired-self describes a person the individual hopes to become in the future.

43. The method as recited in claim 40, further comprising presenting the profile to the individual.

44. A method for providing automated life and career management services to an individual, comprising:
providing a user interface for display on a client device, the user interface containing one or more control panels associated with facilitating personal growth and development, career development, planning and goal setting, job procurement assistance, and achievement and performance monitoring;
recording personal information about an individual when the individual interacts with the one or more control panels;
compiling a personal profile about the individual based on the recorded personal information, the personal profile providing a psychometric portrait of the individual and an occupational profile about the individual; and
providing the personal profile to at least one of an individual and an advisor for purposes of administering life and career management service to the individual.

45. A method for providing automated life and career management services to an individual, comprising:
providing a user interface for display on a client device, the user interface containing one or more control panels providing a mode of operation rendered on the client device associated with facilitating personal growth and development, career development, planning and goal setting, job procurement assistance, and an achievement and performance monitoring; and
providing a navigational mechanism on the one or more control panels, the navigational mechanism comprising icons for selecting between the modes of operation rendered on the client device.

46. The method as recited in claim 45, wherein the navigational mechanism is a navigation wheel containing selectable icons, each selectable icon corresponding to a mode of operation associated with at least one of the personal growth and development, the career development, the planning and goal setting, the job procurement assistance, and the achievement and performance monitoring.

47. A method for providing automated life and career management services to an individual, comprising:
administering psychological assessment instruments to an individual via a user interface displayed on a client device;
administering introspective exercises to the individual via a user interface on a client device;
administering a perceived-self exercise to one or more third party perceivers via a user interface on a client device to ascertain how the individual is perceived by others;
recording a personality profile about the individual based on results received from the psychological assessment instruments, introspective exercises, and the perceived-self exercise, the personality profile including information that describes the individual in three-dimensions: a perceived-self, a desired-self, and a current-self; and
providing access to the personality profile.

48. The method as recited in claim 47, further comprising:
providing career exploration activities to the individual via the user interface;
generating a career foundation report based on the career exploration activities;
providing a career assessment test to the individual via the user interface;
providing best vocational areas within which the individual can begin career exploration, through the use of filtering and selecting one or more career channel categories identified as most interesting based on the career assessment test;
providing selection guides on the user interface for researching, and selecting a primary fit career channel, a secondary fit career channel, and a tertiary fit career channel;
recording a selected primary fit career channel, a secondary fit career channel, and a tertiary fit career channel in an occupational profile; and
providing access to the occupational profile.

49. The method as recited in claim 48, further comprising modeling and forecasting a career development progression, displaying the career development progression, and recording the career development progression as part of the occupational profile.

50. The method as recited in claim 48, further comprising integrating the occupational profile with the personality profile.

51. A method, comprising:
displaying on a display device a mechanism for entering a goal;
displaying on the display device a mechanism for selecting a life arena for classifying the goal in at least one of a personal arena, an occupational arena, a financial arena, a social arena, an educational arena, a leisure arena, and a spiritual arena;
displaying on the display device a mechanism for classifying an importance associated with achieving the goal;
displaying on the display device a mechanism for entering a target date for completing the goal, which is the specific end date when the goal is expected to be accomplished; and
displaying on the display device a mechanism for authenticating the goal.

52. A method, comprising:
providing an interface to a life and career management control system;
receiving a first set of information about an individual, from at least the individual, through the interface;
compiling the first set of information into a comprehensive personal profile;
displaying on a user interface of a client device a job search section for entering information for use in screening and identifying job opportunities; and
displaying personal characteristics identified from the comprehensive personal profile to enable the individual to view those personal characteristics and compare them to requirements for positions associated with the job opportunities displayed in the job search section.

53. The method as recited in claim 53, wherein the personal characteristics displayed comprise at least one of a preferred fit career channel, an occupational signature theme, an occupation mission statement, natural abilities, a most developed skills, and a career progression forecast chart.
